(19) United States
(12) Patent Application Publication
(10) Pub. No.: US 2025/0123076 A1
(43) Pub. Date: Apr. 17, 2025

(54) ELECTRONIC SURVEILLANCE SIGHT AND ACCESSORIES THEREOF

(71) Applicant: Robert Marshall Campbell, Miami, FL (US)

(72) Inventor: Robert Marshall Campbell, Miami, FL (US)

(21) Appl. No.: 16/404,584

(22) Filed: May 6, 2019

Related U.S. Application Data
(60) Provisional application No. 62/667,499, filed on May 5, 2018.

(51) Int. Cl. F41G 3/16; F41G 3/14; F41G 11/00

(52) U.S. Cl. CPC F41G 3/165; F41G 3/145; F41G 11/003

(57) ABSTRACT

A firearm surveillance sight system is disclosed comprising a sight having a plurality of adjustably mounted cameras configured to provide a view of the environment surrounding the user via one or more smart devices. The sight is adjustably mounted to a mounting rail of a firearm, each of the one or more smart devices adjustably mounted to the mounting rail of the firearm or a helmet mounting rail positioned on a helmet of the user.

### CROSS-REFERENCE TO RELATED APPLICATIONS

The enclosed non-provisional patent application claims priority to the pending provisional patent application Ser. No. 62/667,499 titled “Surveillance Device” to Robert Marshall Campbell.

### TECHNICAL FIELD

The embodiments provided herein generally relate to the field of firearm optics and accessories.

### BACKGROUND

Firearm optics and accessories consist of a wide range of devices that attach to and enhance the performance of, or simply work in conjunction with a fire arm, all of which are produced to enhance the abilities of the firearm in one way or another. These accessories consist of various types of sights, scopes, night vision, laser sights, range finders, etc. as well as regular or infrared high-powered lights, tripods, various types of mounting rail systems, etc. This invention would fall more into the sight category but more particularly, this device is a new type of tactical surveillance sighting device as well as accessories for it devised to enhance its tactical sighting and surveilling abilities.

It is well appreciated in the art of weaponry and particularly rifles and hand guns. There have been numerous attempts to develop more efficient firearm accessories that provide a soldier with a level of safety and control in theaters of combat where gun fire must be exchanged to the preservation of the soldier's life; in that first responders, soldiers, and law enforcement personnel often encounter hostile combatants, violent actors or offenders who carry pistols, rifles, or other weapons. Military scenarios, battles and other military operations often occur in urban theaters of combat requiring armed forces to patrol and battle the enemy in towns and cities in these theaters of combat, and our troops often come under fire from enemy combatants and must regularly take cover behind obstacles such as buildings, vehicles, trees, homes, etc. with the remedy to these scenarios being extremely dangerous, that rarely end well.

The problem is that with the friendly combatants' entire body being behind protective cover, a clear linear view to locate the point of fire, or to be able to locate or accurately engage advancing hostile enemy combatants, when it's the only option to the soldier's survival, cannot be accomplished without looking over or around these fortified structures, exposing himself as a target while doing so. This as well as countless other scenarios and duties required of our troops, where an inability to effectively surveil areas and engage targets from positions of protective cover have historically been responsible for countless causalities. The applicant being a Vietnam veteran himself and all too aware of these things, as well as the miserable failures of the prior art to provide our troops with a viable solution to this problem, has been the driving force in his provision of a real solution to this problem. A solution destined to prevent countless future casualties especially in its solution to the ongoing problems that today's troops face on a daily basis, in theaters of urban combat, that has created all new dangers and challenges for today's armed forces, that the applicant's solution literally provides our troops with abilities to once and for all solve.

Included in the following application is a solution to the aforementioned problems. A solution acclaimed by high ranking military personal and advisers consulted as inventions possessing far superior tactical sighting abilities than anything previously devised, that will provide all of our troops with a level of defensive safety, and tactical control, providing abilities that nothing previously devised has ever come close to providing them, that will not only reduce a great number of U.S. casualties, but will also make a tremendous impact on our armed forces level of efficiency and effectiveness. In fact, one official for our special forces consulted remarked that these inventions are doubtless destined to prevent a large percentage of U.S. casualties, that's sure to prove evident at even greater levels in theaters of urban combat, in that they will not only be availed to, but will also provide all of our ground troops far greater abilities of defense and tactical control, which in turn will provide our armed forces with abilities to fight a far more precise and exacting war that operates at a level of efficiency and control, with a far superior tactical advantage, that with even a seriously reduced number of ground troops will very easily and effectively both identify the true hostile enemy combatants, as well as resolve the conflict in a manner where only the true aggressors need pay for their actions.

These abilities will also provide our troops with the ability to fight a much more humane war as well, especially theaters of urban combat. This due to these inventions providing our troops with the ability to maintain a fully unobstructed view of their entire surroundings, and in turn, a full awareness of threat demographics, in that more often than not, hostiles are intermingled in the same environment with innocent non-hostile civilians that quite often are also being victimized by the enemy, with the lines between the two often becoming blurred, and with these abilities to easily distinguish between the two, it will doubtless create substantial reductions in collateral damage as well. All of which additionally helping to establish a reputation for our armed forces of both that of strength but also that of compassion and perceived by those in other countries more as the good guys, there to help them! This as well as to be perceived as much greater threat to future aggression.

This tactical surveillance sight as well as the multi position-able firearm and helmet smart device mounts engineered to work in conjunction with them, also included in this application provides solutions to these problems as well as many others.

This surveillance sights work in conjunction with these accessories in a manner that radically expands and enhances each other's abilities, that in turn provide the user with an all new and never previously accomplished level of defensive safety and tactical control providing abilities, as well as advanced sighting abilities previously never believed possible, as well as provide a broad spectrum of additional abilities and services to the user, all while continuously providing him with the perfect vantage point to the smart device's screen, displaying an unobstructed 360 degree view of both the target and surveilled images of the entire surroundings, providing the user with the ability to surveil his entire perimeter, while simultaneously providing him accurate target acquisition in never previously attainable levels of speed and ease, which the tactical surveillance sight also provides simultaneously with ongoing full, accurate and undiminished level of use of the firearm from literally any position the user positions himself in relation to the firearm and all from positions of total protective cover, without so much as the user's pinky being exposed to incoming fire while doing so.

The applicant been assured that these long overdue and desperately needed safety and control providing abilities that these inventions will provide our troops will literally save countless lives. This as well as provide our troops with numerous other abilities and advantages, for instance even though these surveillance sights and accessories provide services and possess numerous abilities never previously achievable, by sights, most perspective designs are very small and weighing only ounces, that will not only provide them with numerous and desperately needed abilities never previously availed to them, they will likely render pounds of equipment they presently have to take into battle as obsolete, which, should significantly lighten their present heavy load.

These surveillance sights and accessories operate either independently of each other or optionally in conjunction with each other. The surveillance sight itself possesses the ability to be mounted and sighted-in on either the top or bottom mounting rail of the firearm and on any position thereon, as well as the option of employing their operational abilities in conjunction with smart glasses, smart watches, or even a laptop when initially sighting them in.

These surveillance sights on the other hand working in conjunction with the multiple position-able smart device mounts are in every way also devised to provide the user numerous operational options as well as the highest levels of versatility and range of optional employment, to best supply the tactical and sighting needs of various types of fire arms employing them. They are also engineered in a manner that takes total advantage of each other's abilities, that in turn provide them the ability to operate at the highest levels of versatility and operational efficiency.

These things become ever increasing evident with the multi position-ability ease of function and added abilities, as well as all of the advantages of the larger viewing screen and advanced computing abilities provided when used in conjunction with a smartphone or small tablet, or optionally with a version thereof made exclusively for our armed forces, mounted in the multi position-able smart device mount. These smart device mounts themselves are in every way also devised to provide not only maximum levels of virility, but they are also devised in a manner that both suffers no unequal forces of inertia during recoil, as well as in a manner that all of their rotationally position-able joints very solidly lock the smart device mounted therein into any position of horizontal, vertical, or pivotal adjustment with one quick fluid and easy motion by the user, and thus providing him with the perfect vantage point of the screen of the smart device mounted therein, to literally any position he could possibly position himself in relation to the firearm, providing him the perfect vantage point of the screen of the smart device mounted therein, but also provide him the ability to do so with a great level of speed and efficiency, with time often being critical to his very survival.

These multi position-able smart device mounts also provide the user with six different mounting options, these being on the front or to either side of any helmet our armed forces employs; as well as three positional mounting options provided by the firearm rail mountable version of this smart device mount, that provides the user with mounting options anywhere on the left side, top, or even on the mounting rail on the right side of the firearm; thus also providing an easily operate-able option for left handed users as well. They are in every way also devised to provide the user with numerous applicational options and highest levels of versatility and range of optional employment, to best supply the tactical and sighting needs of various types of fire arms employing them. These tactical surveillance sights also possess multiple mounting options and are devised to provide the user numerous applicational options of adaption that broadens both their range of versatility and adaptability, without diminishing from their abilities or range of function in any way, but together will provide our troops with an all new level of tactical control and defensive safety providing abilities that no device or combinations thereof has ever come close to providing them.

These tactical surveillance sights and accessory's provision of unmatched level of safety and control providing abilities will prove essential to the favorable outcome of countless battlefield scenarios, as well as in the performance of a broad range of duties required of our troops that have previously been responsible for countless numbers of casualties. These duties becoming even far more dangerous for our troops due to many of the all new challenges that urban warfare has presented, where these battles take place in towns and cities that in turn creates all new battlefield scenarios where the ability to both locate all of the hidden dangers and identify the enemy has proven absolutely paramount to both the mission's success, as well as in its cost in casualties. These challenges include a broad range very common scenarios, whether having to take cover due to incoming fire and as a result thereof, having to locate the point of fire as well as surveil the area for other incoming hostiles or developing enemy scenarios, with the troop's only remedy to this being to commit, or in other words to stick his head around the corner with the enemy just lying in wait for him to do so.

These dangers are certainly not exclusive to actually being under fire with no optional avenues of escape, which in turn usually means, with no viable solution, and rarely produce a positive outcome. Scenarios of this nature, of a soldier having to take cover from incoming fire, while possessing no ability to either locate its source, or accurately returning fire on same, have historically pledged all theaters of combat and have in turn been one of the largest sources of casualties. With these dangers seriously amplified in theaters of urban combat, that proves evident while in the performance of countless additional duties required of our troops on a daily basis that puts them in harm's way, whether on watch or on patrol and having to traverse between one point to another and having to peek around the corners of buildings or locate the point of fire as well as surveil the area or other residing dangers to ensure the path needed to take is clear and safe to proceed. As well as when clearing buildings of snippers or other hostiles and having to remain behind protective cover while viewing down hallways or into rooms where suspected hostiles reside.

This surveillance sight as well as the tactical accessories that are devised to work in conjunction with them, are also employable on all firearms employed by our armed forces, special forces, secret service, law informant and others. This simply meaning that all of their far superior defense, safety, and control providing abilities will be easily providable to all that are in so desperate need of them, in that they will provide our combat troops with an all new and far advanced level of safety and control providing abilities that will prove evident in the performance of a full range of duties required of them, from the least to their absolute most dangerous, that have historically resulted in countless U.S. casualties, especially in theaters of urban combat which has created all new challenges for today's troops and our military leaders, in that enemy combatants take up sniper positions and create enemy strongholds in towns and cities that are immersed with innocent civilians, that quite often are also being victimized, by them as well with the lines between the two often becoming blurred. The absence of any real viable solution provided by the prior art for these problems, has been the source of a huge number of U.S. casualties, to say nothing of an unacceptable amount of needless collateral damage as well.

Our military's inability to provide our troops with any real and effective solution to these problems from this point forward need to only to be a lesson in history. The applicant has been assured by high ranking military personnel that this invention will not only save a large percentage of our troops' lives, but will allow our military to fight a much more efficient, effective, and humane war as well, where only the true hostiles and aggressors that pose a threat to the lives of our troops and the innocent suffer the consequences of their actions.

This new tactical surveillance sight and their accessories provide the user with both the target and surveilled images in a 360-degree view of his entire surroundings to a smart device to be viewable in the viewing screen thereof by means of cameras that possess the abilities to provide their images to the smart device in a total of five different modes known by the applicant, with two of these modes providing their targeting and surveilled images directly from the surveillance sight to the smart device. These modes of image transference in turn requiring absolutely no internet or service connection of any sort. This simply meaning that they maintain a full range of their sighting abilities anywhere in the world. With the only real noticeable abilities lost being that of communication and surfing the web. In that all computing abilities which provide all function as well as all sighting abilities, zooming abilities, night vision G.P.S. and countless add others remaining constant, although research into advanced abilities that 5-g will provide these sights would also crossover providing additional sighting advantages as well.

The basic presently availed modes of operation that all testing has been done in has been both by means of wireless, or radio transition where the smart device receives its targeting and surveilled images from both the tactical surveillance sight as well as an additional rear viewing camera integral to the smart device mount itself if employed. With an optional mode of image transference by means of wire transmission much the same manner that an endoscope or borescope supplies its image to a smartphone or smart device by means of a mini cable and plug that plugs into the charging port of the smart device. With these two optional modes of image transference being selectively employed by the user and probably only offered as an optional mode of image transference for the targeting camera itself in the same manner as all other camera sighting device inventions of the applicants.

These two optional modes of point to point image transference, from the targeting camera itself to the smart device, also provide certain advantages over each other that adds both versatility and sighting advantages These tactical surveillance sights in all of their variations and types possess not only radically superior tactical, defense, safety, and control providing abilities to the user than anything previously devised, but they also all provide countless profound and desperately needed sighting abilities as well, never previously achieved by sights of any type ever devised. Nor by that of scopes for that matter Such as that of variable zooming abilities provided by the smart device itself instantly transforming these sights un magnified images into high powered scopes, with variable magnifying abilities, which have performed quite well with even some of the extremely small spy cameras tested but perform extremely well employed with some of the still very small but much higher end cameras.

One of these cameras was actually a bit longer actually provides optical zooming as well which provides the user with the ability to additionally zoom the optically zoomed image provided by the sighting and surveillance cameras that actually provide their images to the smart device in a digitized form which actually enables the user with some rather amazing zooming abilities in that when the optically zoomed images are once again digitally zoomed by the smart device itself their image is magnified in multiples of the original image. In other words, for the sake of simple math if the optically zoomed images are delivered to and displayed in the screen of the smart device zoomed, say at a magnification of ten times, and that image is then enlarged another ten times digitally by means of the smart device, the original un magnified image would be displayed in the screen of the smart device is literally magnified 100 times. This meaning these sights equipped with this option for the targeting camera working in conjunction with the variable zooming abilities that the smart device provides these sights these sights already possess, would provide our snipers with targeting abilities that far surpass any scope of any kind. The actual employment of cameras with optical zooming abilities would add profound advantages to sighting at very distant targets which may or may not merit their employment do to their present disadvantages which are cost which presently their very inhibitive, size, in that there somewhat longer, as well as their electrical consumption, being a bit more. Numbers show present feasibility, but also show non-present practicality which is sure to change as time progresses and the positive advantage's start out-weighing the negative dis-advantages. Which research shows may be fairly soon.

These surveillance sights also possess very effective night viewing abilities as well also simply provided by means of component choices in that all cameras tested in these sights possessed infrared viewing cameras additionally providing them with very efficient night viewing abilities as well when either employing them in conjunction with separately mounted infrared illuminators or by means of the incorporation of infrared LED or laser illuminators provide these sights. In that not only can these illuminators provide a very sufficient amount of infrared light while requiring very little energy to do so, they can also provide the user with target acquiring abilities at great distances as well simply by means of narrowing the light's beam while at the same time zooming the targeting camera's image out, which in turn also narrows its field of view as well, some very small high powered illuminators tested proved relative efficiency more than an eighth of a mile away and of course of course this was with a very narrow field of view, and operate much better at closer distances.

These sights are also devised in a manner that provides these sights with profoundly fast and easy target acquiring abilities as well, attributable both the manner that all camera sight inventions of the applicant's capture both their surveilled and target images from a position inside the camera sight's housing, with the camera lenses themselves positioned in very close proximity to the sight's forward viewing window, where all acquire a very wide field of view, with the center camera thereof being the targeting camera which is hard mounted directly behind, and in perfect linear alignment, with the target reticle, which acquires a very wide view of the area with a perfectly centered target reticle in the screen of the smart device. This in turn providing the user with lightning fast and easy target acquisition, in that not only is the target instantly locatable, but one can accurately take aim on same faster than he could point at it, in that target acquisition is accomplished simply by means of placing the reticle that's perfectly centered in the screen of the smart device on the target. This action can be accomplished with the same amount of speed and ease when employing only the targeting camera itself and the others turned off, this still providing the user with a very wide unmagnified image of the area with their perfectly centered reticle. Thus, enabling the sight with the ability to provide the broad range of viewing options with the ability to instantly transform this into a variable high-powered scope, which no other sight or scope can possibly do.

No other sight ever devised possesses even this ability in that it can only be accomplished by means of the manner the applicant devised this sight. Which alone provides the user with far greater sighting abilities than any sight previously devised. Of course, the full surveillance sight itself due to the way its devised possesses abilities and provides services never imagined possible,

These sights' cameras being hard mounted with their lens in perfect linear alignment directly behind the reticle should pretty well eliminate the effects of lateral parallax or target deviation of any kind as well.

These tactical surveillance sights and their accessories, in all of their variations and types, are all devised in a manner that both the surveillance sight and the smart device take full advantage of each other's abilities in every way, and with smartphones and other smart devices actually being extremely high tech computers, in turn, transform them into profoundly high-tech computerized sights with countless additional amazing and desperately needed abilities, not limited to that of communication, G.P.S. or recording for evidentiary purposes, but also countless additional abilities the computing abilities of the smart device provides such as, numerous options of image arrangement and enhancement, even with some of the more simplistic and common apps, providing abilities such as viewing the 4 received images, each of which providing different 90 degree angles of view arranged with the top half of the smart device's screen displaying the image of one entire side of the user, and with the bottom of the screen displaying the other, as well as the ability to optionally view them corporately or individually as well as in separate windows or full screen, as well as the ability of individually zooming in on the target or any of the other angels of view either in their separate windows or full screen. Of course, the window displaying the targeting image is always easy recognized in that its always displaying it's perfectly centered reticle, that when brought full screen provides the user with not only lightning fast and easy target acquisition but also very easy target recognition and locating abilities as well.

With all aforementioned abilities paling in comparison to these sights and their accessory's defensive, tactical, safety, and control providing abilities, abilities literally predicted by military officials consulted to prevent a large percentage of U.S. casualties. These abilities primarily consisting of their continuous and ongoing provision of all of their aforementioned abilities while experiencing no real loss of speed, efficiency, target acquiring abilities, or any of the other broad range of unique and desperately needed abilities they possess, from positions of total protective cover, such as from behind a wall, building, tree, vehicle, out of a trench, ditch, or other. This, as well as, from literally any position the user would possibly have to, or even could position himself to in relation to the firearm, without exposing the slightest part of his body to incoming fire in any way while doing so.

This tactical surveillance sight includes cameras with WIFI or other radio frequency transmitting abilities that corporately provide their surveilled and targeting images to a smart device to be viewed in a screen thereof. The forward-facing camera is the actual targeting camera. This camera is hard mounted directly behind and in perfect linear alignment with the target reticle which is reflected off of the inside surface of the sight's viewing window which also corporately provides its targeting image to the smart device by means of radio or WIFI transmitters along with the other surveilled images, or optionally by wire with the plug portion of which plugging into the charging receptacle on the smart device, with all images provided by this surveillance sight being simultaneously, or individually, viewable in the screen of said smart device.

The forward portion of this sight in the present design of this embodiment houses the camera or cameras that provide the targeting image, as well as a large portion of the surveilled image or images to the smart device, where these images along with an optional additional camera's image would all be viewable in the screen thereof. This additional camera image would be optionally providable by means of a rear viewing camera that's an integral part of a height and angularly adjustable armature that's attachable to and adjustable on either the firearm or helmet multi position-able smart device mount also included in this application.

These mounts as well as the rear viewing cameras were devised and devised to provide an added all around level of versatility and operational ease and efficiency to all of camera sighting inventions of the applicant, and were devised in a manner that provides the user with both the target image, as well as all surveilled images that make up a full 360 degree view of the user's entire surroundings and is additionally devised in a manner that the images they provide are totally un-obstructed angles of view, but they also provide the user with the perfect vantage point of these images displayed in the screen of the smart device from literally any position he could or would possibly have to position himself in relation to the firearm.

This along with these tactical surveillance sight's ability to be mounted and accurately sighted in on either the top or bottom mounting rails of the firearm and provide their surveilled and target images there, which provides the user with many positional mounting options that provide various advantages that would vary, due both to the type of firearm they are employed on, as well as its tactical or non-tactical needs. For instance, when employing the helmet mountable version of this mount, the user's options of firearms to employ in conjunction with it would pretty much be limitless due the size and weight of the actual surveillance sight itself.

It works very well mounted on the bottom rails of pistols. In fact, the applicant's first rough prototype of these types of sights were initially tested mounted on the bottom rail of a pistol, with targets and the surrounding area viewed on a laptop as well as a with a smart phone held in the other hand, but whether the user is employing the helmet or firearm multi-position-able smart device mount in conjunction with this tactical surveillance sight mounted and sighted in on either the top, or bottom, mounting rail and out towards the muzzle of the firearm, whether behind a wall, tree, building, vehicle, or other, the user need simply to extend just the end portion of the barrel far enough to expose the forward portion of the surveillance sight that's mounted on the forward portion of the firearms mounting rail, just beyond the outer edge of the vehicle, tree, out of a ditch, building, or from where ever else he had to take cover.

At this point, the user is provided not only with the fully un-obstructed 270 degree view provided by the surveillance sight itself, but is also provided with the additional 90 un-obstructed view provided by the vertically and laterally adjustable rear viewing camera, integral to the back portion of the multi position-able firearm, or helmet mount itself, which in most cases would already be positionally adjusted to maintain a fully unobstructed view of the entire area behind the user, which this rear viewing camera would maintain, simply due to it being an integral part of the smart device mount itself.

These multi-position-ably adjustable smart phone mounts are devised in a manner in all of their configurations that provide them the ability to be quickly, fluidly and easily adjusted to any of their positions of vertical, horizontal or pivotal angles of adjustment, with an extreme level of speed, ease and efficiency, which is accomplished with one quick fluid and easy motion by means of the user simply grasping the smart device or the smart device mount itself and applying either downward or lateral pressure, or a combination thereof, while positioning the smart device. This pressure disengages their locking mechanisms that solidly locks these joints together at their various points of rotation, which in turn solidly reengages their locking mechanisms solidly relocking them together once the user releases the smart device after positionally adjusting same to its newly desired position.

This position literally being any position he would possibly have to position himself in relation to the firearm to remain behind protective cover, all with not only an ongoing, perfect vantage point of the screen of the smart device displaying both the target and surveilled images therein, all while the rear viewing camera being an integral part of the smart device mount itself also maintains it's perfect vantage point of the area behind the user, while never requiring further adjustments by the user to do so, which in turn not only provides the user with an ongoing unobstructed visual of his entire surroundings, whether out in the open or from any position of total protective cover.

These tactical surveillance sight and these accessories abilities for it certainly don't stop there, in that they also maintain their provision of all of their aforementioned abilities while simultaneously also maintaining their full and undiminished provision of the full accurate use of the firearm from any position of full protective cover as well, which is accomplished from any of these positions by simply taking aim on them, which is accomplished as fast and easily as if the user was performing this task while standing in a wide open position with no protective cover, in that the only thing required of the user to acquire accurate target acquisition, and engage same, from behind any position of total protective cover he had to position himself behind, is accomplished by means of the simple extension of just the very end portion of the firearm with the surveillance sight mounted there on, beyond protective cover far enough to acquire target acquisition, while remaining totally behind protective cover while doing so.

Maintaining the perfect vantage point of the screen of the smart device is also accomplished at the same time, by means of the simple grasping and positioning of the smart device while doing so. Some positional and targeting scenarios additionally require the user to partially rotate the firearm to one side to maintain total protective cover of the user's hands as well while doing so, in which case the user would also pivot the screen of the smart devise downward to a desired angle as well during the same quick easy one-handed positioning process. The repositioning of the smart device during this process is only required by the user when employing the firearm mountable version of this multi position-able smart device mount, in that when employing the helmet versions of this mount, the positioning of both the smart device as well as the positioning of the rear viewing camera once positionally adjusted, its provision of the targeting and surveilling images provided by the positional orientation of the smart device remains constant due to it being integrally connected, and positionally adjusted on the helmet itself.

These helmet smart device mounts, as well as the firearm versions of these mounts, are also devised in a manner that provides the user with the ability to quickly take them in and out of service, by positioning the smart device flat up against the top or side of the helmet of firearm solidly and safely out of the way when not employed, with the ability to redeploy them in the same quick and easy manner when needed simply and easily by means of a reversing of the aforementioned process

The provision of both the full accurate use of the firearm as well as the ability to surveil the entire 360 degree radius of his entire surroundings from behind or out of any structure, object, or place that would provide protective cover, such as from behind a wall, building, vehicle, tree, or out of a trench, ditch or other position, the user has a fully un-obstructed view that makes up a full radius, this due both to the size of the viewing screen thereof, which proves evident in the performance of all of these sights' modes of operation, whether in that of surveillance and target acquisition as well as the multi-window functions and applications of same, but also in that of the countless, functions and applications that require touch screen programming and modes of operation, that radically expand both their tactical and non-tactical range of abilities.

The following, as well as some other portions of this application, describe the forward sight adjustable portion of this tactical surveillance sight that provides the sight adjustable sighting as the largest portion of surveillance viewing abilities of this surveillance sight. All are illustrated and described as possessing three cameras with an un-zoomed viewing angle of 90 degrees each, with the additional rear viewing camera portion of the multi-position-able firearm and helmet smart device mount possessing the same 90 degree field of view as the others and would also be viewable in the screen of the smart device along with the other three, with the four making up the fully un-obstructed 360 degree view which may or may not be the actual number of cameras employed or the actual viewing angles thereof but were described and illustrated as such for several reasons. Firstly, for the ease of understanding, secondly that all testing was done with four cameras, which proved to be very operationally efficient. Although the applicant is fully aware of other camera options and viewing angle and display options but the following mode in all testing has proven as being one very operationally efficient option.

In these four images provided by the targeting and surveillance cameras thereof that provide a full un-obstructed view of both the targeting image as well as the rest or the users entire surroundings, the forward rail mountable and sight adjustable portion of this tactical sight that provides the largest portion of the surveilled area is described as possessing three cameras, all of which possess a 90-degree field of view with the combination of the three possessing a 270-degree field of view that starts partially behind the left side of the user and extends all the way around the front and partially behind the right side of the user, with the center camera providing the sight adjustable target image. An additional rear viewing camera is optionally provided that is integral to a height and angularly adjustable armature made as an integral portion of the back side of a smart phone or smart device mount, also included in this in this patent application.

This height and angle-adjustable camera provides the additional 90 degree field of view to the smart device to be viewed either simultaneously or individually along with the additional surveilled, sighted-in target image provided by the tactical camera sight itself, and displayed in the screen of the smart device, each with the rear viewing camera possessing the same field of view as the other three, with the four making up the 360 degrees, with the smart device mounted thereon, providing the viewing screen for the digital images provided by the cameras that corporately possess 4 cameras that are positionally oriented in a manner that provides the user with a totally unobstructed 360 degree view of his surroundings at all times, when this tactical surveillance sight is working in conjunction with either the firearm or helmet multi-position-able smart device mount equipped with its multi-position-able rear viewing camera deployed.

The housing that is mountable to firearm rail mount's forward portion would be partitioned off into a separate compartment that would be separate from the battery compartment. These cameras would be solidly mounted and positionally orientated with their camera lenses positionally oriented to each other, and angularly positioned as to provide a full wide view, extending from behind and to the left side of the user, and extending all the way across to behind, and to the right side of the user, with each camera providing a wide viewing angle of 90 degrees, so that these three cameras would provide the user with a 270 degree view, although these individual viewing angles may differ due to an executive decision made once the best operational field of view is determined for the center forward viewing camera, this camera being the actual combination surveillance and targeting, or sighting camera that supplies its image to the smart device optionally, by radio of Wi-Fi transmitter or by wire plugged into the charging port of the smart device itself.

This camera, as well as additional cameras housed behind the viewing window or windows of the surveillance sight, would provide the user with images of the area in front, to each side, and behind the user, with the center camera's view starting where the left side viewing camera's view ends, and ending where the right side viewing camera's view starts, and it is this forward facing camera that provides this sight's targeting or sighting abilities. It's lens would be perfectly centered directly behind the reticle reflected off the inside of the forward viewing window, allowing this sight to be sighted in by means of a sight-adjustable rail mount, integral to the sight housing, or optionally within its own sight adjustable tube inside the sights housing in the same manner as that of many conventional sights are sighted by mechanical adjustments to the tubes alignment itself.

The added zooming abilities of these camera's images in the screen of the smart device, that work in conjunction with this surveillance sight, provide this sight with the abilities to both additionally widen the field of view of these images, either individually, or corporately, or more importantly, to individually bring up and zoom in and magnify the images individually on the screen of the smartphone or smart device being employed, in the multi position-able firearm of helmet smart device mount included in this patent application.

The images provided by these cameras are transferrable and are viewable in the screen of the smart device in five different modes known to the applicant, but most testing of this device was performed in four of these modes that would be applicable to a portable unit. All tested extremely well in all of these different modes of image transference, with all of these different modes possessing certain advantages and disadvantages to each other. Two of these of these modes of image transference do not require an internet connection through a computer or router of any sort. The first of these modes of operation would be with the smart device receiving its image directly by cable or optionally by radio transmission from the radio or WIFI transmitting modules that would be an internal part of, or separately mounted inside the housings, and tied into the individual cameras by means of electrical communication.

Simply meaning that the smart device would receive its transferred and/or transmitted images straight from the cable and/or the camera's individual WIFI transmitting modules tied into the camera or cameras portion of this tactical computerized surveillance sight, with the ability to view all of the images provided by the cameras in the screen of the smart device either individually, or all at once, along with the added ability to select the various images provided by the individual cameras and enlarge them individually or selectively with the smart device either individually, along with the added ability to select various images and enlarge or selectively arrange them on the screen. Provided by the computing abilities of the smart device working in conjunction with it.

All of these things providing the user with not only far superior sighting abilities than any other firearm sight ever devised, but also providing him with the ability to very thoroughly surveil his entire perimeter, as well as engage targets when under fire from same, from a totally safe, secure area, without any portion of his body being exposed to incoming fire while doing so, simply by means of sticking the muzzle of the firearm with this tactical surveillance sight primarily mounted on bottom mounting rail thereof, just past the edge of a building, wall, tree, vehicle, out of a trench, over a berm, or other, where the tactical surveillance sight can acquire a clear wide view of the area. This while maintaining a visual of the area behind the user at all times as well, by means of the rear viewing camera that is an integral part of the smart device mount.

Then with the added abilities of this smart device mount to quickly and easily position the screen of the smart device into any position or angle of rotation of a full radius of 360 degrees both vertically or horizontally or pivotally, with one quick fluid motion with one hand, to any desired angel of view to maintain the perfect vantage point of the screen of the smart device providing the user with the ability to both maintain a full visual of his entire surroundings, as well as to engage targets literally from any position the user would have to position himself in relation to the firearm and even while even while under heavy incoming enemy fire.

This, as well as, with the ability to selectively zoom any of the camera's images displayed in the four windows on the screen of the smart device either individually in the four windows on the screen of the smart device or selective bring them up full screen to zoom in on sniper positions or other residing dangers, or to better sight in on other targets of greater distance. This tactical surveillance sight would provide as few as only one troop with the ability to maintain total control of the battle without having to expose even the slightest part of his body to incoming fire while doing so.

Another added feature of these smart device mounts their selves being that whether deployed and in use or stored either on the firearm laid up against the side of the firearm or the helmet versions thereof lock solidly into their positions of non-deployment stored flat up agents the helmet. Neither the smart device or the smart device mount obstructs or hinders the full operational use or full functional abilities of any of the other equipment availed to the user in any way, this holds true even for the firearm mountable version of this mount weather employed mounted on the top or side rail of the firearm.

This also enabled, by means of its ability to pivot and solidly lock up against the firearm laid locked down flat against the upper rail of the firearm or laid down and solidly up against the side of the firearm. In other words, none of the components of this tactical surveillance sight, neither the smart device mount with rear viewing camera, nor the housed rail mountable surveillance camera sight portion of this tactical surveillance sight mounted on the bottom rail of the firearm, would obstruct or hinder operational use of any of the other equipment on the firearm, such as other night vision equipment, range finders, other sights, or scope's rail mounted lights or other equipment in any way, this as well as the ability to reemploy them with one quick easy motion with one hand, as well of course with the ability to simply remove them by means of their quick release mount they will likely all employ and store them. which is an additional reason all components of this tactical surveillance sight were devised in the manner that they were.

The rear viewing camera portion of these smart device mounts of the applicants. is integral to a position-able armature that mounts to and becomes an integral part of the multi-position-able smart device mount, the image of which being viewable in the same smart device's screen, where the target and all other surveilled images are viewed. The ability to easily position the smart device to its perfect vantage point to the user and maintain a visual of the smart device's screen and the rest of the surveilled and target images therein with this added ability of maintaining a visual of the area behind himself the entire time for other approaching dangers from behind, no matter what position he could position himself in relation to the firearm, which will doubtless prove to be a real added advantage in numerous ways.

This surveillance sight also possesses a tremendous level of operational efficiency when operating in other modes of operation, as well but in a lesser working range of 270 degrees. This surveillance sight's other modes of operation, and image acquisition for this surveillance sight consist of smart watch worn on the inside side of the wrist, smart glasses, goggles, as well as wrist band smartphone case mount which have been experimented with and worked extremely well.

There are different types of these cameras and radio transmitters applicable in this surveillance sight. The actual application choices of which would be made in the same manner, as an executive decision, after thorough examination and evaluations can be made. The types of cameras and radio transmitters illustrated in all of drawings and descriptions of this application are of the same type used in the rough prototype. for this invention. This being of the same type that are employed in most of the higher-end, infrared viewing spy cameras and endoscopes.

These cameras are of the same basic types of cameras employed in the higher quality smart phones and are available in the same approximate size and quality with several types and models available with even far greater resiliency ratings than those employed in the best smartphones. Another difference with these cameras and those found in smart phones being that they are also available equipped with either their own integral or separate little WIFI transmitters. These cameras are also available with infrared viewing abilities, which in most cases this device would employ. This additionally equips this device with quite amazing night viewing abilities as well, when working in conjunction with infrared illuminators, limited only by distance,

This, along with variable-zooming abilities and very efficient night vision, provides this little sight with the added abilities of a scope with variable zooming with service providing abilities 24-7. The smartphone and its screen not only provide extremely fast and easy target acquisition when time is critical to the user's survival, but with this screen actually being the screen of a very sophisticated computer, which a smart phone actually is, it turns this device into an extremely high-tech computerized surveillance sight.

The applicant has been assured that this invention, along with the level of safety and control providing abilities that this tactical surveillance sight provides, will not only save a large, percentage of our military's casualties, but will also make a tremendous impact on our military's efficiency and effectiveness as well, especially in theaters of urban combat, where hostile combatants take up positions where non-hostiles reside, and with the hostiles taking up more sniper type positions, it has created an environment where our troop's inability to reveal and be made aware of these dangers that continuously befall them, simply due to their inability to reveal these dangers without having to expose themselves as a target to do so, has been one of the greatest source of U.S. casualties. This has created all new challenges for our ground troops and military leaders as well. The ability to see and to be made aware of and deal with these dangers quite often being absolutely critical to their very survival. This patent application provides a solution for these problems as well as many others.

This invention alone provides the user with a range of control and safety providing abilities that not only radically out-perform the prior art in numerous ways, but the added abilities that this new tactical surveillance sight provides, abilities such as the added safety that night viewing abilities that this tactical surveillance sight provides to the user during the day, is the same view that the tactical surveillance sight provides the user at night, with an individual infrared illuminator providing the light for each camera. This in turn providing the user with a full view of his entire surroundings illuminated by light that only he and his smart device can see, the ability of being able to zoom in on any individual area to reveal hidden dangers such as sniper positions or enemy combatants taking up positions behind open windows, on top of buildings, from greater distances.

This while maintaining a visual of the rest of his surroundings at the same time by means of the images provided by the additional cameras in the tactical surveillance sight system as well as the ability to quickly return viewing angles of these cameras either individually or corporately into a full wide view such as when having to surveil various rooms and hiding places as well as around corners and down halls when clearing buildings of hostiles, without exposing the user as a target while doing so.

This tactical surveillance sight's ability to view any and all parts of his surroundings from any position he would have to position himself in relation to the firearm to reveal the hidden dangers therein, providing the user not only with the ability to totally take and maintain control of a battle from a safe secured position, with the user's entire body remaining totally behind protective cover while doing so, but will also provide the user with a new level of safety while performing a broad range of duties required of him, ranging from the least to the absolute most dangerous, in ways never before believed possible, that no other device or combinations thereof has ever come remotely close to providing our troops.

These duties along with the aforementioned include scenarios such as when either on patrol or at any time for that matter in a theater of combat our troops will often come under fire and have to duck behind any protestive cover available such as the corner of a building, behind a tree, vehicle or behind a berm, etc. creating an extremely dangerous but all too common scenario that rarely ends well, in that a soldiers only remedy, when in this situation being, first locate the point of fire, as well as to assess the area for other immediate dangers befalling them, with the only option to the soldier's survival, previously accomplished only by looking over or around protective cover to do so, with enemy hostile combatants just lying in wait for the friendly combatants to do so.

This new tactical surveillance sight working in conjunction with the multi position-able smart device mount also included in this patent application will provide our troops with the ability to turn scenarios of this nature totally around, with the ability to remain totally behind protective cover with not only the ability to locate the point of fire and surveil the immediate area for other dangers, such as advancing hostiles, or other developing enemy scenarios, but also with the time and ability to zoom in on other possible sniper positions on top of roofs or from just inside darkened rooms, shooting out of windows, or other, as well as with the time and control to thoroughly distinguish between enemy hostiles and the innocent civilians, which quite often are simply being victimized by the enemy. This as well, providing our troops with the ability to both distinguish between, as well as, to engage the hostile enemy combatants, in a manner that deals only with the aggressor and to only those that pose an imminent threat to the survival of the soldier. All of this and more while the user remains totally behind protective cover without the slightest portion of his body being exposed to enemy fire.

This tactical surveillance sight provides the user with this same level of safety and control, while performing almost all of his duties, whether on patrol, standing watch, surveilling an enemy strong hold, or simply traversing between one post to another with the soldier having to peak around the corner of buildings or other to assess the dangers in the path he must take, exposing himself as a target while doing so, as well as exposing his presence and whereabouts to the enemy, which has never produced a positive outcome, and quite often to the soldier's peril or even loss of life. The applicant has been assured that this invention will prevent a large percentage of American casualties, and save a great number of our troop's lives, not only due to the advanced control and safety providing abilities that this invention possesses, but also due to this invention's broad range of versatility and applicability, providing this tactical surveillance sight with the ability to be employed by any firearm availed to our military, whether ground forces, special forces, or even law enforcement such as S.W.A.T.; whether standard issue or special tactical. In other words, these advanced control and safety providing abilities can be easily provided to all of this nation's personnel that put their lives on the line daily and are in such desperate need of these abilities.

It is well appreciated in the art of weaponry and particularly rifles and handguns. There have been numerous attempts to develop more efficient, accurate firearm sights and user-friendly sight systems. In general, firearm sights and sight accessories have long been established for mounting on rifles and pistols. Such accessories include red dot sights, high powered lights, night vision, scopes, laser sights, and the like. All of the aforementioned firearm sights and accessories aid in locating and pin pointing a target, but offers no provision for the user to remain behind protective cover while doing so.

The applicant could not find any prior art capable of accomplishing the tasks or that possess the abilities of the applicant's device. All seem to only be devised with their entire efforts directed solely towards the abilities of engaging targets from behind protective cover, with probably only one that completes that task with any measurable level of effect, and all others detectable provision of service to that effect being extremely limited, in that their solution, whether being a firearm or device, was actually devised to provide a completely different service, usually that of high-tech sighting, with very little innovative forethought or engineering directed towards their surveilling abilities at all, nor do they provide any solution of any sort to the overall defensive safety, control, and tactical needs of our troops. Nor could they in any way even be a component to affect thereof, due firstly to their inability possibly perform the full task themselves, and secondly due to their solution limited as they all are never being devised with any provision of adaptation or incorporation enabling another solution to the possibility of a greater effect or level of service Although even if they would they would all would fall miserably short of providing any real level of effect to the full problem. This due to the many problems that none of the prior art has been capable of solving.

The prior art offers no solution to the soldier to both very effectively surveil, as well as engage targets if deemed necessary to the troop's survival, an entire area from a safe, secure position.

The user of the firearm must become exposed as a target in order to do so, which presents a severe problem to the preservation of the soldier's life. Current available solutions devised to reveal hidden dangers or to provide the user with surveillance and tactical abilities capable of maintaining a visual of the user's entire surroundings, as well as to engage targets, that provide the user of the firearm with the ability to remain totally behind protective cover while doing so, and that is applicable to any firearm with a mounting rail, was absolutely unfindable in the prior art. In fact, the applicant could not find any invention capable of accomplishing more than one of these tasks and usually even that with very limited levels of efficiency. With all seriously lacking fall and falling miserably short in one way or another in the overall functional range of their abilities they could possibly provide at a remotely acceptable level of safety and control providing abilities to our troops in the broad range of actual battlefield scenarios that constantly befall them. Of course, with some failing far worse than others.

In fact, there has only really one that was actually developed with the ability to engage a target from protective cover, with any level of measurable success, this being the Israeli corner shot with even it not really devised to, or capable of efficiently surveil an area from protective cover, Although no tactical firearm accessory, or even a device that possess the abilities or operates in the same manner that has either been integrated into other tactical firearm accessories, or is an integral part of a tactical firearm, the applicant has been unable to find. With only a couple that aren't even sights but regular scopes that are capable of displaying their target image on a smart phone with neither devised remotely like, or that was made for, or could in anyway perform any of the abilities or could possibly provide any of the services that the applicants solution provides, with the smartphone employed for recording and very high tech. distance sighting computations.

And with the applicant finding only one actual tactical device that could be remotely construed as operating in a similar manner of that functions in a remotely similar manner, this being in the Israeli Corner Shot, which is actually a tactical firearm, which has for many years been the only thing that could provide the user with the ability engage targets from protective cover, which in spite of its deficiencies and somewhat restrictive range of defensive and safety providing abilities, lack of firepower or accuracy at any real distance, but primarily with its inability to provide the few tactical and safety providing abilities they actually possess, to anything but itself, and thus only able to provide a very small percentage of our troops, or our allies armed forces, special forces, secret service, law enforcement, homeland security or others in such desperate need of even the limited tactical and safety providing abilities they could provide, still couldn't be availed to them for numerous reasons, from being very cost restrictive not only due to their exclusive complexity and high manufacturing cost, but also due to their manufacturers taking advantage of the fact, that until now, they have been the only viable option.

This, as well as, this being only one type of firearm that doesn't really fit the position or provide a viable replacement for any type of firearm they would be taking the place of. In fact, their total lack of versatility and exclusivity unto themselves is one of their greatest problems. All of which, as well as countless other problems, inabilities and insufficiencies plaguing the prior art. The applicant's solutions not only suffer from absolutely none of the aforementioned problems, but they also provide full and highly effective solutions for all of them as, well as many others that from this point forward the vast numbers of casualties attributable to the prior arts inabilities a better solution to these problems will simply be looked back on as a very costly lesson in history.

The Israeli corner shot is an invention that consists of a pistol mounted on the forward portion of a ratcheting bendable stock. This firearm also has a video camera with a super imposed reticle that is wired to a 2½-inch monitor with an LED screen affixed to the lower left side of the rifle stock in a non-rotatable 90 degree viewing position in relation to the rifle stock, which is where camera supplies its target image to the user from, meaning this target screen is only viewable from the left side of the firearm, meaning the user can only operate the firearm from the left side of the firearm, which is true with any of the prior art. The ratcheting bendable forward portion of this firearm, where the pistol and camera are located, are other separate components that work in conjunction with each other and with the actual sight portion of these electronics being mounted separately from the pistol, and with the pistol mechanically clamped in place on the forward portion of this firearm, with a servo that operates the trigger from the stock portion of the firearm and the rest of its electronic components that superimpose its reticle, as well as other sighting components and electronics that the applicant could not uncover by research. The bulk of these components are also mounted to the outer pivoting pistol portion of this firearm that is pivot-ably connected to the stock portion of the firearm with the 2½″ monitor and trigger-like servo activation switch hard wired to the stock portion of the firearm that pivotably swings and is lockable to either side of the firearm's stock portion.

This tactical firearm, which was actually devised to provide a soldier with the ability to quickly engage targets from protective cover, and not really devised for surveillance purposes, although never the less, this tactical firearm, possesses a camera that supplies an image to a monitor, that also provides the user with the ability to remain behind protective cover while employing same, but only with a very restrictive field of view in a manner that requires, the entire firearm minus the stock to be exposed to in coming fire as well as to the revelation of his position this is also where their similarities pretty much end. This, as well as, the actual surveilling abilities that this tactical firearm inadvertently possesses is very limited as well, in that the prior art provides the user with these abilities in only one direction. This being the direction the firearm is actually aiming and from only one position, on the left side of the firearm from a 2½ inch monitor located at the lower forward portion of the left side of the stock, so even their similarities, as few as they are, are quite different, and the many differences include, but are not limited to, this device possessing only one camera that just views the area where the firearm is actually aiming, and in a much narrower field of view, and provides no visual of the areas to each side or behind the user to provide advanced warnings of developing enemy scenarios, or advancing hostile combatants, or a number of other impending dangers either approaching or preexisting that could befall him from any of his surroundings, the knowledge of which quite often being absolutely critical to his survival.

This firearm, as well as any other prior art, was primarily invented to be able to engage targets from a safe position and in most cases of close quarter combat that don't require a high degree of accuracy or distance, this firearm performs an adequate job. Of course, a target must be located before it can be engaged, and quite often the target is much more than 50 or 100 feet away.

The camera and its mode of operation is completely different than that of the applicant's as well, due to its many separately mounted components that make up its tactical sight that provides its targeting image to its own monitor, that is an integral part of this firearm, as well as, the entire firearm with all components being exclusive to itself, and with its firepower limited to the fire power, range, and accuracy limited to only what a pistol can provide. For this reason as well as others, this firearm is seen and employed by the military only as a secondary or specialty firearm and not to take the place of a soldier's primary firearm, meaning due to their numerous inabilities to fit in and operate in harmony with the rest of our armed forces equipment as well as im sure their very restrictive cost limited their employment to our armed forces are never actually supplied, our ground troops, in turn, are never provided with any the actual tactical and safety providing abilities from them and if they ever were, this entire firearm would have to be carried into battle along with the rest of the soldier's equipment, not only adding an additional eight and a half pounds to the soldier's existing heavy load, but also getting in the way when not in use. But because of these things, also limiting the soldier's range of mobility, as well as hindering the soldier's effectiveness in the use the rest of the equipment availed to him and in the performance of other duties required of him.

Additionally, this firearm also being limited in the positions that a soldier must place himself to the effective use of the firearm due to the location and non-position-ability of the target screen, which can present a problem in many of the more restrictive places a soldier would have to position himself to remain out of the line of fire, and literally prevents the user from operating the firearm at all from the entire right side of the firearm which seriously limits its range of safety providing abilities as well as its full effective range of use of the firearm and its overall tactical abilities.

This as well as pretty much all prior arts inability to equip the broad range and many different types of firearms availed to our armed forces, such as the numerous types of rifles, whether standard issue or the various types of specialty and automatic rifles as well as the numerous types of firearms in general, the prior art has also tragically failed to supply.

In fact, all of the prior art exhibits numerous problems and deficiencies that prove evident in many ways, which all contribute to the lack and range of protection that they could possibly offer the user, with most consisting of multiple bulky electronic devices, all of which being dependent on each other to operate as a functioning unit, with the smallest non-functioning component thereof rendering all inoperable. Not only limiting dependability, but quite often rendering them as only repairable by their manufactures. All prior art also not only takes up a lot of space and quite often hinders the normal operation of much of the standard issue equipment that he must constantly rely on, but the prior art also adds additional weight to a soldier's existing heavy load. With this weight being substantial the lightest being over 65 pounds with some of our troops having to carry well over 125 pounds into battle.

These current solutions even create numerous problems unto themselves with all being manufactured as a firearm or as an integral part of a particular firearm, or exclusive to one type of firearm, also not adds to the weight problem with all being limited to only one or very limited range of service they could possibly provide, with the prior art suffering from these things as well a great many other deficiencies that latterly hinders or severally restricts the few services they could possibly provide of ever actually being of any real service to the solder just due to their being cumulatively restrictive, not only in their burdensome combined weight, but also by being in the way and hindering the deployment or normal operating ability of each other in numerous ways, quite often to the degree of creating more problems than their solution could possibly provide that proves evident in numerous ways, not just in their exclusivity unto themselves and lack of adaptability but also in their inability to offer any real services or rang of abilities to going as far as not even cohesively operating well in conjunction with, not only the various types of firearms but even much of the other standard issue equipment availed to our armed forces. These problems plaguing all prior art in one way or degree or another additionally lessening their tactical abilities limited, as they are of very little use, in that their abilities rarely get into the hands of those that need them the most.

These problems wouldn't even exist if only a little additional forethought and a wider conceptional vision of the overall tactical and safety providing needs of our armed forces was taken into consideration as a whole, along with greater effort put forth, applied toward innovative engineering, directed toward the development of devices with a greater range of application, versatility, effectiveness, and portability, so that a greater level of safety and control could be provided for all of our troops where these abilities are so desperately needed, and the prior art has so miserably fallen short of providing them.

The biggest problem with the prior art by far is in its lack versatility, adaptability and inability to actually equip any of the actual firearms that are availed to our troops with any of their actual tactical abilities, limited as they may be and it is their exclusivity unto themselves being an integral part of a particular firearm, more than anything that render them of no real use to our troops or only availed to a very small percentage of them, to say nothing of the lack of overall range of control and safety providing abilities and services that they actually provide the user in actual battle field scenarios.

This tactical firearm, as well as the other prior art, is also very limited in its technical abilities as well. That forethought and innovative engineering directed towards something as simple as the incorporation of a common smart device may have been a better choice, as an electronic and technology source, if possibly applicable to its solution, which would enable them to access a vast number of other extremely useful abilities, both tactical and non-tactical, in that a smart phone or smart device is actually a highly sophisticated computer, that if realized and initially devised to be properly integrated into their solution with compatible electronic components to take full advantage of each other's abilities, this alone can radically expand an electronic device's range of abilities, and range of use, and most importantly, the range of safety providing abilities and services that they could have possibly offered the user.

Although no amount of electronic sophistication can make up for a lack of vision, innovation, forethought and creative engineering required to devise a device that most effectively and efficiently provides the user with the ability to reveal and be made aware of the existing dangers in his soundings and engage same, to the preservation of the user and his fellow soldier's lives. This invention's ability to surveil an entire area from protective cover, in a full perimeter around the user, to reveal the dangers therein that could befall him at any time, quite often being absolutely critical to the user's survival. This is why a device that much better provides these services is so desperately needed, but also a device that possesses a broad range of adaptably, versatility, and application so that these control and safety providing abilities that can be provided to everybody in our armed forces that are in such desperate need of these abilities, which all prior art has so miserably fallen short of providing them in countless ways.

This is why an invention like the applicant's is so desperately needed in that, there is no prior art that possesses any real ability to provide our troops with a level of safety and control that actually avails them with the ability to remain totally behind protective cover along with the full accurate and undiminished use of the firearm, and from any position in relation to the firearm while maintaining a constant visual their entire soundings while doing so. Or provides them with a broad range of tactical control and defensive safety providing abilities that hold true in a broad range duty required of them, and battlefield scenarios befalling them.

This tactical surveillance sight, as well as the multi position-able smart device mount of the applicant's is not only applicable to any firearm that our armed forces, special forces, secret service, or law enforcement employs, but they also radically outperform the prior art's control and safety providing abilities, as well as in their sighting abilities in numerous ways, abilities the applicant's been assured will save countless lives. This invention also being applicable to all of the firearms availed to those that defend this nation and our allies, will in turn provide them all with their profoundly unique and so desperately needed control and safety providing abilities. would not only also be easily mounted on all of the firearms availed to those that defend this nation but could also provide them with these abilities, very cost effectively, in that this device could be manufactured to the highest of mill spec. standards for a very low per unit cost t simply meaning they can easily be provided to all those that are in so desperate need of them.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The core invention included in this patent application is named Tactical Surveillance Sight. This tactical surveillance sight includes both a rail mount integral to a camera housing, either of which being sight adjustable and attachable to a firearm mounting rail. This housing includes at least one battery in electrical communication with at least one camera, housed in forward portion, said housing this, or these said camera or cameras, positionally oriented to receive its or their image or images, from forward at least one viewing window, with forward viewing camera, positionally oriented in linear alignment with a reticle image reflected off of the inside surface of said camera viewing window reticle, provided by a reticle selector powered with its own power source and located on or made as an integral part of the said housing and reticle projection unit, positionally oriented to project its reticle beam to be reflected off of the partially reflective inside surface, off the camera's viewing window, directly in front of said forward viewing camera's lens, with image received from same, as well any additional cameras images, provided by any additional cameras housed therein, provided to a smart device to be viewed in the screen thereof these images are transferred or transmitted optionally by means of WI-FI or radio transmission and wire transference in the same manner and modes employed by all other camera sighting device inventions of the applicants.

These images also viewable in conjunction with an additional image provided by means of an additional rear viewing camera with its image optionally provided to the smart device in the same manner as the others three, to be viewable in the viewing screen of the smart device thereof, with the target reticle appearing centered in the image provided by the forward viewing camera housed inside the surveillance sight.

This surveillance sight optionally equipped with at least one infrared illuminator, said housing also housing at least one battery in electrical communication with said infrared illuminator.

This smart device mount additionally possessing a mounting base as an integral portion thereof, for the mechanical attachment of an armature clamping portion providing multiple position adjustability of said armature, an additional rear viewing camera and camera housing integral to or mechanically fasten-able to said armature, the image of said rear viewing camera viewable in said smart device viewing screen, along with the with images provided by said cameras in the aforementioned surveillance sight, with all transferred to the smart device mounted in said multi-position-able smart device mount to be viewable in the viewing screen thereof, with the target reticle appearing centered in the image provided by the forward viewing camera and delivered to said smart device by wire in a mode of direct communication or optionally by means of radio or WIFI transmission.

A multi positionally adjustable smart device mount attachable to the mounting rails of firearms and helmets. This smart device mount is also included in this application consists of a multi-position able smartphone or small tablet mount attachable to the top or side mounting rail of a firearm. The mounting portion of this multi position-able smart device mount coupled to a firearm rail mount, and mechanically attachable to a firearm mounting rail, and positionally orientable there-on to provide user with said image or images displayed in said smart device screen, from multiple viewing positions in relation to the firearm as well as a modified version of this multi-position able smart device mount that's mountable to the side rails or to the forward mounting base of any of the numerous types of U.S. combat helmets.

All versions of these multi-position able smart device mounts possessing at least two rotate ably adjustable joints that lock into a plurality of optional positions of rotation, and into its desired position by means of a plurality of teeth that span from an inner portion of the joint out to the outer perimeter thereof progressively becoming wider as they extend outward to the outer periphery portion of each joint.

These interlocking teeth consist of both male and female portions the inner sides of which are slightly mitered in a manner that these teeth solidly lock into each other when their pressed into each other. This compressible force that solidly locks these teeth into each other is accomplished by means of a spring located in an inner portion of the housings of each joint this spring both compress-ably and solidly locks the male portions of these teeth into their female portions after rotational adjustment.

This same spring also provides the user with the ability to change the vertical and horizontal rotational adjustment of these joints at will simply by means of applying compressible pressure to the smart device mount or armature in the direction that compresses the internal spring that in turn separates the male teeth from their female interlocking teeth, at which time positional adjustment of same is accomplished by means rotating the smart device mount to its desired position of vertical or horizontal rotation, then simply by means of releasing the presser compressing the internal spring, this same spring re compress-ably and solidly relocks the slightly tapered or mitered teeth back into each other as well as the smart device and mount or armature into its newly desired position of adjustment with one quick and easy fluid motion.

This smart device mount possessing an additionally a mounting base integral and part of a back portion of the smart device mounting platform portion of this mount, for the mechanical attachment of an armature clamping portion providing multiple position adjustability of said armature, an additional rear viewing camera and camera housing integral to or mechanically fasten-able to said armature, the image of said rear viewing camera viewable in said smart device viewing screen, along with the with images provided by said cameras in the aforementioned surveillance sight, with all transferred to the smart device mounted in said multi-position-able smart device mount to be viewable in the viewing screen thereof, with the target reticle appearing centered in the image provided by the forward viewing camera and delivered to said smart device by wire in a mode of direct communication. Or optionally by means of radio or WIFI transmission.

It is the objective of this invention to provide the highest level of safety and control providing abilities to our armed forces, law enforcement, with highly advanced surveillance abilities that will equip our troops with the ability to maintain a full unobstructed visual of 360 degrees of their entire surroundings to provide the user with advanced warning of impending dangers such as sniper positions or other hostiles lurking in the shadows behind open windows, or other while maintaining these abilities, as well as the full accurate use of a firearm, even while under heavy incoming enemy fire, providing the user with the ability to remain in total control of a battle, while remaining safe, totally behind protective cover. This, as well as, to provide the user with these advanced safety-providing abilities at highest-level possible, whether at night or during the day, while performing a broad range of duties required of them that previously left them in harm's way historically responsible for countless U.S. casualties.

Its yet another objective of the present invention to provide our troops with an advanced tactical surveillance and sight that is highly versatile that will provide advanced levels of safety and control abilities.

It is yet another objective of the present invention to provide advanced tactical firearm tactical surveillance sights for firearms that are small and light, yet possess a wide range of advanced control and safety providing abilities that are also highly versatile, quickly and easily attachable, portable and more importantly, applicable to any type of firearm employed by our military, both that of ground troops and special forces as well as all types of tactical firearms employed by our law enforcement, such as S.W.A.T. and secret service personnel. To place these advanced control and safety providing abilities where their so desperately needed, being in the hands of all personnel that put their lives on the line every day, to provide the safety and preserve the freedom for all others of nation.

Finally, it is an objective of the present invention to provide a superior tactical surveillance sight accessory for firearms that incorporates all of the above-mentioned functions, abilities, objects, and features.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a profile view of a surveillance sight attached to a firearm mounting rail, according to some embodiments;

FIG. 2A illustrates an overhead view of the surveillance device as if the top portion of the surveillance device was removed to reveal the inner components therein, according to some embodiments;

FIG. 2B illustrates a slight off skew image of removeable wall that the side viewing combination camera and WiFi transmitting modules as well as the center target viewing camera, according to some embodiments;

FIG. 3 illustrates a profile view of a surveillance sight that is additionally equipped with three infrared illuminators, according to some embodiments;

FIG. 4 illustrates an overhead view of the surveillance sight as if the top portion of the surveillance device was removed to reveal its inner components, according to some embodiments;

FIG. 5A illustrates an overhead view of the surveillance sight equipped with infrared illuminators, according to some embodiments;

FIG. 5B illustrates a slightly off skew image of the removeable wall integral to the camera mounting bases, according to some embodiments;

FIG. 6 illustrates a profile view of the surveillance sight, according to some embodiments;

FIG. 7 illustrates an overhead view of the surveillance device with infrared illuminators incorporated into its housing, according to some embodiments;

FIG. 8 illustrates a profile view of the multi-position ably adjustable smart device mount consisting of a helmet side rail mounting base as well as two rotate-ably position-able joints; according to some embodiments;

FIG. 9 illustrates a profile view of the multi-position ably adjustable smart device mount in a position of storage; according to some embodiments;

FIG. 10 illustrates a profile view of a multi-position ably adjustable smart device mount in a position of employment, according to some embodiments;

FIG. 11 illustrates a profile view of the multi-positionably adjustable smart device mount that's mountable on the forward mounting base, according to some embodiments;

FIG. 12A-E illustrate the basic components of the first type of helmet-mountable and multi-positionable smart device mounts, according to some embodiments;

FIG. 13A-D illustrate the smart device mounting components, according to some embodiments;

FIG. 14 illustrates a profile view of the embodiment of the multi-position ably adjustable smart device mount locked into a position of employment, according to some embodiments;

FIG. 15 illustrates a profile view of the embodiment of the multi-position ably adjustable smart device mount, according to some embodiments;

FIG. 16 illustrates a front elevation view of the smart device mount locked into a position of employment, according to some embodiments;

FIG. 17 illustrates a top plan view of the smart device mount locked into a position of employment, according to some embodiments;

FIG. 18 illustrates a top plan view of the smart device mount, according to some embodiments;

FIG. 19A-C illustrate the adjustable joints and the components thereof, according to some embodiments;

FIG. 20A-C illustrate the components of the adjustable joints, according to some embodiments;

FIG. 21A-B illustrate the helmet mounts, according to some embodiments;

FIG. 22 illustrates a frontal view of the firearm mountable adjustable smart device mount, according to some embodiments;

FIG. 23 illustrates a firearm mountable adjustable smart device mount, according to some embodiments;

FIG. 24A-B illustrate the mounting base portion of the helmet side mount, according to some embodiments;

FIG. 25A-B illustrate the mounting base portion, according to some embodiments;

FIG. 26A-B illustrate a top view of armature 36 and an exploded view of the side or front helmet-mountable smart device mount including same, according to some embodiments;

FIG. 27 illustrates an exploded view of height and angular adjustable rear-viewing camera armature mounting base, according to some embodiments;

FIG. 28 illustrates a rear view of the armature and rear-view mounting camera, according to some embodiments; and

FIG. 29 illustrates a rear-view mounting camera, according to some embodiments.

### DETAILED DESCRIPTION

### Multiple Camera Surveillance Sight

The present invention advantageously provides a multiple camera surveillance sight for the attachment to a firearm. This sight is devised to work in conjunction with smart devices of various types that display the digital images provided by cameras internally housed in this sight. This sight is illustrated as employing three cameras that wirelessly transmit their image to the smart device or optionally by direct wire communication to be viewed in the screen thereof at the same time.

Or selectively, this sight possesses a broad range of applications and types of smart devices that it will work in conjunction with and provides the user with sighting abilities with a 270-degree field of view and out performs all prior art many times over by its self, but this sight is additionally devised to optionally work in conjunction with other firearm accessory inventions of the applicants, most of which consist of multi-position-able smart device mounts for smartphone or a small tablet that possess an additional rear viewing camera that provides its image to the smart device as well.

Accordingly, the components have been represented where appropriate by conventional symbols in the drawings, showing only those specific details that are pertinent to understanding the embodiments of the present invention so as not to obscure the disclosure with details that will be readily apparent to those of ordinary skill in the art.

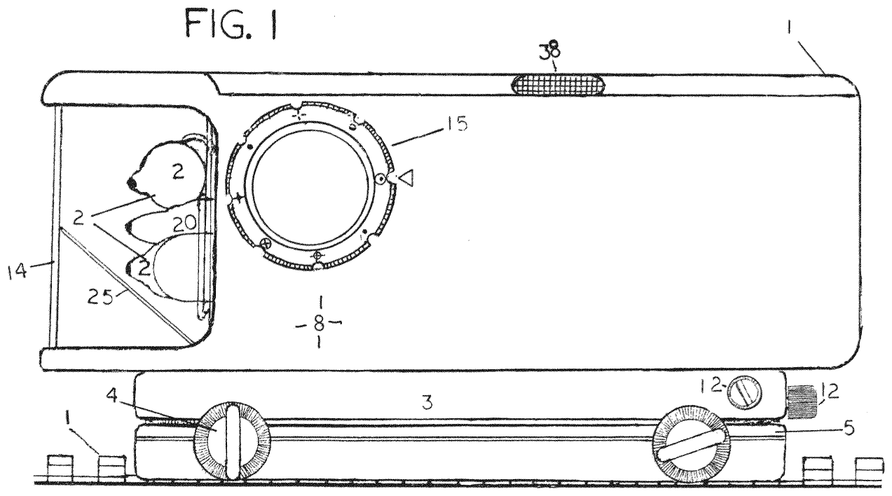

FIG. 1 is a profile view of a surveillance sight attached to a firearm's mounting rail #1, in an embodiment taught here in. Viewing window 14 is where the internal cameras receive their images. Side viewing combination cameras 2 and WIFI transmitting modules are illustrated. These cameras receive their surveilled images from angles 45 degrees forward to 45 degrees aft on each side of the user and wirelessly transmit signals to a smart device to be viewed in the screen thereof. Camera 20 is the forward viewing camera that is mounted directly behind the reflected image of the target reticle projected beam 25. This beam is reflected off of the inside partially reflective surface of the viewing window 14. This target acquiring camera 20 receives and provides the target image as well as the image of the area between the inner viewing angels of the side viewing cameras 2 through viewing window 14 and transmits, the image by means of WIFI or radio transmitting modules. Or alternately transfers the cameras image receive of same by wire transmission to the smart device to be viewed in the screen thereof. The sight's target reticle consists of a tiny light beam 25 powered by a button battery housed inside the reticle selector 15. This reticle selector provides the user with reticle choices in size, shape, and intensity. This reticle is projected onto a slightly reflectively tinted inside surface of the viewing window, centered and in perfect linear alignment with the forward-facing camera 20 lens, and with both always remaining in the same positional orientation to each other, as well as to the sight's housing. An integral portion 3 of the surveillance sight's housing 8 and is adjustably coupled to the rail mount 5. Sight adjustments 12 adjustments that vertically and latterly adjust the positional angles between 3, being part of the sight's housing, and the rail mount 5, by means of clock wise and counter clockwise rotation of sight adjustments. The sight adjustments 12 change both the vertical and horizontal angle of the surveillance sight's housing 8 in its relation to the firearms mounting rail 1, and thus to the barrel of the firearm so that when the firearm is being sighted in, it is the camera's perfectly centered view behind the target reticle's image that is being sighted in to the target. Thus, also creating what should prove a very accurate sight, in that it suffers no effects of lateral parallax reticle deviation whatsoever, and with the target reticle always remaining perpetually centered in the screen of the smart device additionally providing the user with unmatched fast and easy target acquisition. Rail mount 5 is provided. These rail mounts 5 come in several different types and designs but all of which are made for the attachment of firearm accessories of various types to the mounting rails. A mounting rail 1 is provided which also comes in several different types, the main type being a picatinny rail as illustrated in this drawing. This tactical surveillance device may be manufactured in models with rail mounts 5 of different types, such as to be attached t the bottom rails of a pistol. These mounting rails are also made in multiple configurations to be mounted on the tops sides and bottoms of almost any type of firearm, in accordance with the principles of the present embodiment.

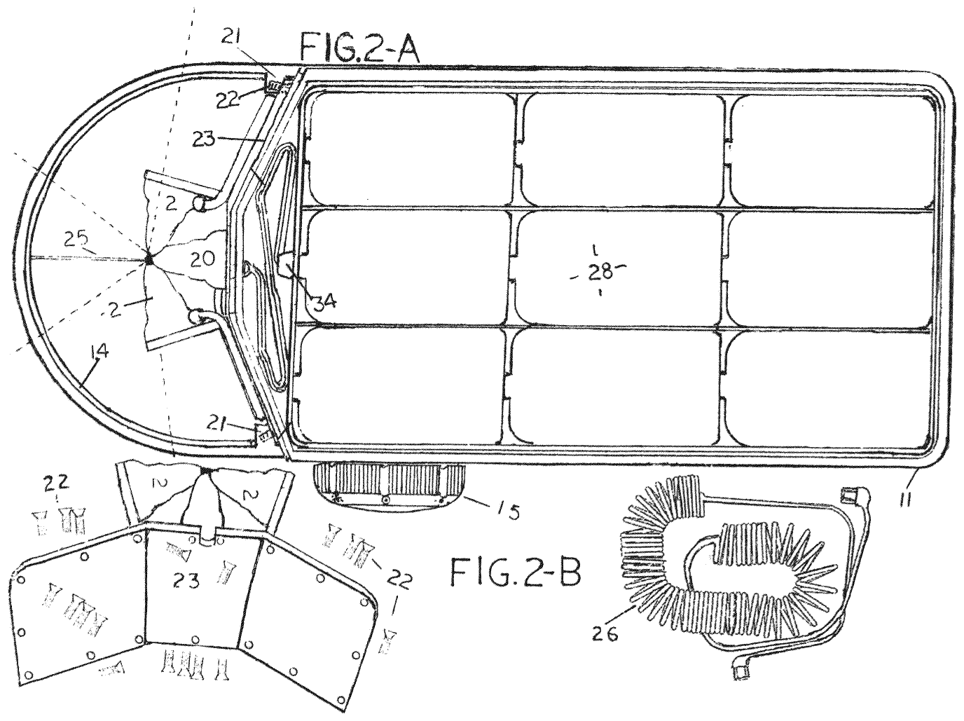

Now referring to FIG. 2-A which is an overhead view of the surveillance sight as if the top portion thereof was removed to reveal the inner components thereof in an embodiment taught herein. Combination cameras 2 and WIFI or radio transmitting modules are shown. The center target viewing camera 20 that provides its image to the smart device by WIFI or radio transmitting modules as well as alternatively by wire communication with a perfectly centered target reticle viewable in the screen thereof. Both of these cameras could be of the same basic types of actual cameras that are just differently equipped or either being one of several others researched by the applicant that would be applicable to and lend themselves quite well and even provide much better service than the high resolution spy type cameras with internal WIFI transmitting modules and antennas as well as the hardwired camera as illustrated, in that, all of these other types of cameras are either available or equip-able in this same manner although some types of these camera's WIFI transmitting modules and antennas are hardwired to their cameras and would be separately mountable. A much higher quality camera or even one providing optical zooming may be used for at least the center targeting camera, with the options always become greater. These cameras illustrated are of the same basic types and quality employed in the higher quality smart phones with extremely high-resolution ratings, their primary differences being the WIFI transmitting modules as well as these cameras also being available with infrared viewing abilities, as all others researched. These types of spy cameras lend themselves to this application very well and are also widely available.

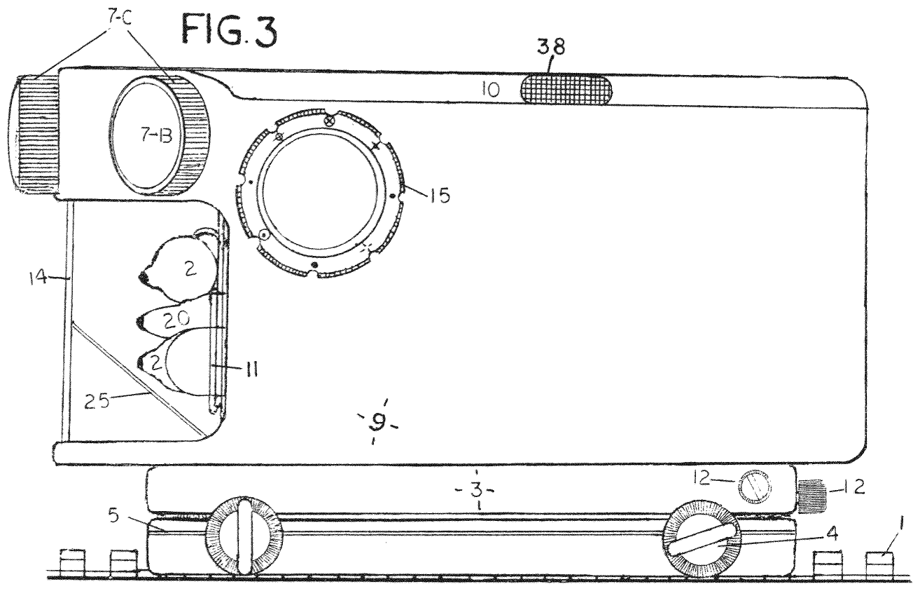

The forward viewing window 14 is where cameras 2 and camera 20 receive their surveilled and target images. An optional design 23 of a removeable wall that is integral to the camera mounting bases is provided. This wall being removable and resealable is simply illustrated in this manner as a viable option that would provide both easy assemblage and access for possible future repairs or maintenance. This removable wall 23 is mechanically fasten-able to a cleat 21, extending around the inner perimeter of and part of the housing 8 that wall 23 is attachable to. Also shown is the wire 23 that completes electrical communication between the removeable battery pack and the switches. An electrical plug 34 that completes the circuit between the battery pack seen in FIG. 3A and wire 32 consisting of a mini USB plug as well as allowing this battery pack to be charged in or out of the sight is illustrated. A partially coiled up cable 26-B is shown that transfers its target image from the forward viewing camera that provides the target image to the smart device, in accordance with the principles of the present embodiment.

FIG. 2-B is a slightly off skew image of the small removeable wall 23 integral to the combination camera and WIFI transmitting module's mounting bases, in an embodiment taught herein. Mechanical fasteners 22 are utilized for the attachment of the wall 23 to a cleat extending around the inner perimeter of the housing for the attachment of the wall 23. This wall was devised in this manner simply to facilitate access to the inner workings of the camera housing portion of the surveillance sight both for the purpose of assemblage as well as for the ability to remove and reseal this wall in case future component access were needed for repair or replacement. Manufacturing this surveillance sight with a removable and resealable viewing window would also serve the same purpose, in accordance with the principles of the present embodiment.

FIG. 3 is a profile view of a surveillance sight that is additionally equipped with three infrared illuminators, in an embodiment taught herein. The viewing window 14 is where three combination cameras and WIFI transmitting modules 2, as well as the forward facing and target acquiring camera 20 receive their images from, both in front and to each side and partially behind the user. The mounting rail 1 on the firearm is shown. The rail mount 5 is mechanically fastened to the firearms mounting rail #1. An integral portion 5 of the surveillance sight's housing 9 makes up the upper sight adjustable portion of the sight. The surveillance sight's sight adjustments are accomplished by the rotational adjustments, made to the lateral and vertical sight adjustments 12. Also illustrated are the tension adjusting knobs 4 for the attachment of the surveillance sight to the mounting rail 1. Notice the attachment and removal mode for this rail mount would be accomplished by means of the loosening and tightening of the thumb screws 4. These are illustrated as having a wide inner radiused cut out slot in the center portion of the knob. This is designed in this manner so the user in the field could simply use a coin like a quarter as a screwdriver for the removal or installment thereof. There are several different quick release lever type rail mounts on the market that this device may alternatively employ as well. This surveillance sight's battery compartment located in the aft portion of housing 9 as well as the rest of the surveillance sight would be higher profile due to the infrared illuminators which would simply require more battery compacity which the higher profile battery compartment would easily accommodate by means of larger or additional batteries. The reticle beam 25 is projected up and reflected off the inside surface of the camera's viewing window directionally in front of the forward-facing camera's 20 lens, in accordance with the principles of the present embodiment. Cord 26 transfers the target image provided by the forward viewing camera to the smart device. that simply plugs into the charging port of the smartphone or smart device which is a mini USB port. The coiled portion is simply for length options, as well as additional length requirements needed during rotational adjustments, if a multilocational smart device mount is being employed. A charging port 33 is provided in accordance with the principles of the present embodiment.

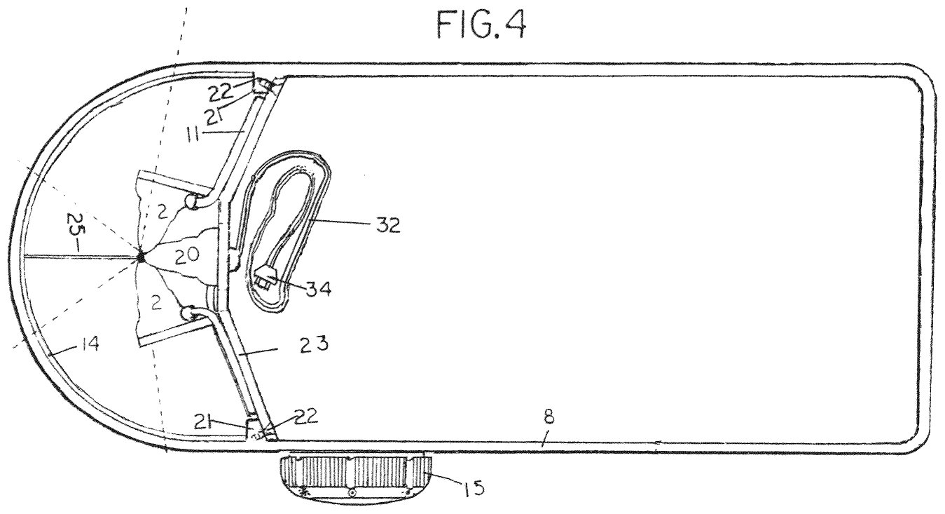

FIG. 4 is an overhead view of the surveillance sight as if the top portion of the surveillance device was removed to reveal the inner components therein, in an embodiment taught herein. Combination cameras 2 and WIFI transmitting modules are shown as well as the antennas 11 for same. The forward-facing camera 20 is mounted in perfect alignment and directly behind the target reticle that provides its target image to the smart device. The viewing window 14 is where cameras 2 and 20 receive their surveilled and target images. The reticle beam 25 is reflected off the inner surface of the viewing window directly in front of the center forward viewing cameras lens. A profile view of the reticle selector 15 is illustrated. This switch would turn the reticle on and off, meaning that unless in heavy combat conditions, this switch would remain in its off position and the forward viewing camera would simply be used for surveillance purposes in the same manner as the side and rear viewing cameras. This due to this surveillance sight's primary function being for that of surveillance purposes, but once turned on the reticle selector provides the user with several different shaped reticles, in different sizes and brightness levels; this reticle selector would possess its own power supply as well, consisting of a button battery housed inside. The selector 32 is the wire cord that completes electrical communication between the removeable battery pack 29 and the switches 23, a USB plug 34 plugs into USB receptacle on the battery pack so that entire pack can be removed and charged separately. A removable wall 23 is attached to a cleat 21 that extends around the inner perimeter of the housing 8 that wall 23 is attachable to, in accordance with the principles of the present embodiment.

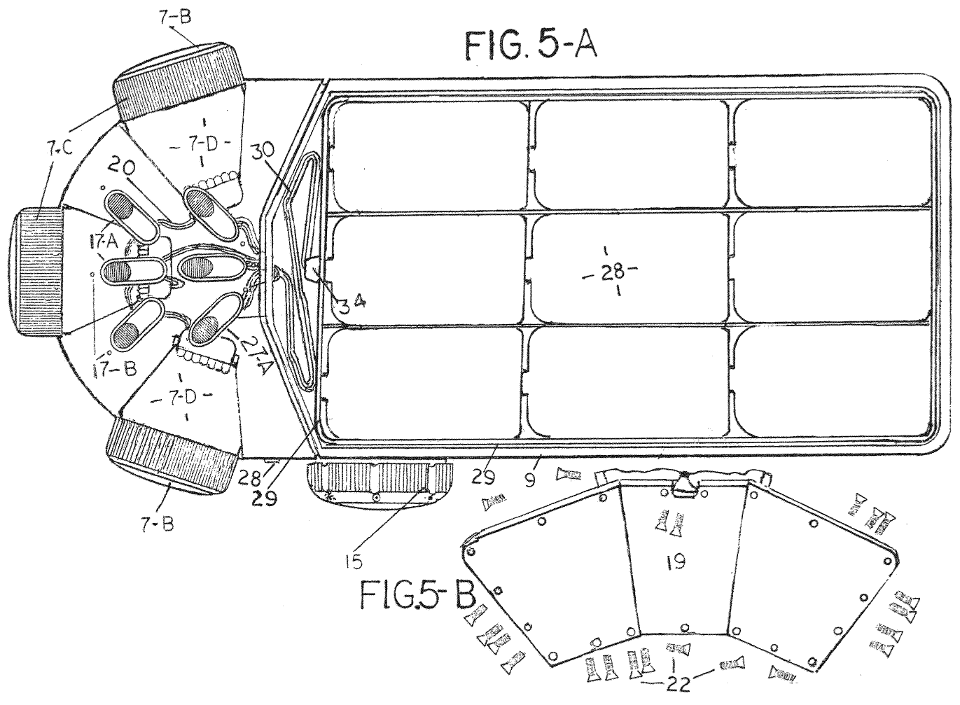

FIG. 5-A is an overhead view of the surveillance device with a removeable battery pack 29 in an embodiment taught herein. This battery pack is designed in this manner for several reasons, firstly to provide easy access to the access door 23 or 19, secondly so the entire battery pack could be quickly and easily removed and replaced, thirdly so the entire battery pack could either be recharged in place by plugging the unit into a wall or vehicle charger or removed and charged separately in the same manner. This battery pack would also be partially opened both on the bottom and the top as to not retain moisture or contaminants, the same being true for the battery compartment portion of the device inside the housing itself, providing for all around ease of cleaning and maintenance. This battery pack's electrical communication with the rest of the device is both connected and removed by means of electrical plug 34. The male portion of this plug would be of the same type as the male portion of the plug on the charger and the female or the receptacle portion of this plug on the battery pack itself would be of the same type and size as the charging port itself, 28, so these batteries would very easily recharge in or out of the surveillance sight itself as well as an extra battery pack could be brought along with the rest of the gear on an extended mission. One could also simply remove the battery pack and quickly replace the batteries also if disposable batteries where being employed. This model of this device is also equipped with infrared illuminators 7-D. All these surveillance sights would probably employ infrared viewable cameras and work in conjunction with infrared illuminators but with these as illustrated with the illuminators aiming the same direction with the ability to narrow the beam width and be able to surveil areas at great distances directly where viewing, would be a definite advantage as well. This drawing is illustrated as if the outer forward portion of the housing 9 of the device was removed to reveal the infrared illuminators housed therein, although these light housings 7-D would be an integral part of the device's housing 9. This drawing shows these infrared illuminators as being LED type infrared illuminators. Laser illuminators would be the option. The actual LED bulb or laser illuminator component access for removal and replacement or repair, would be accomplished by means of removal of the lens 7B and lens housing 7C which doubles as the beam width adjustment knob. Switches 27-B complete the circuit between the batteries and the individual infrared illuminators. Wires 27-A complete the circuit between the batteries and the individual combination cameras and WIFI transmitters 2 and 20 this wiring facilitating electrical communication between the battery power source and switches as well as between switches 27-B and infrared illuminators and switches and combination cameras and WIFI transmitters.

FIG. 5-B is a slightly off skew image of removeable wall 19, integral to the camera mounting bases in an embodiment taught herein. Mechanical fasteners 22 are for the attachment of the wall 19 to a cleat extending around the inner perimeter of the housing for the attachment of the wall 19. Wall 19 may be of the same type and configuration as wall 23 in illustration 2-B, with the only difference being that this wall is vertically longer or higher. This simply due to the additional height of this design of the invention that is equipped with the infrared illuminators. The battery pack 29 illustrated in FIG. 3 would also be higher and contain an additional level or larger batteries for the power requirements of the infrared illuminators, although these drawings actually show this device as having a much larger battery supply than it could possibly require to maintain an extended run time so the actual battery capacity would likely be far less than as illustrated. Both infrared LED and laser illuminators are very energy efficient, which simply means that a great deal of light can be produced by these infrared illuminators for extended periods of time with very little battery use. The cameras themselves also require very little battery use as well. The tiny radio transmitting module's power consumption can be a bit more but most of these radio transmitting modules in these spy cameras transmit their signal several hundred feet and still requiring very little power, with many of these spy cameras being in things like pens or wrist watches with very little battery capacity, in that their power requirements are actually totally proportionate to the strength of their signal and the distance that they transmit their signal, and with the smart device never needing to be more than a couple of feet away, and the user never needing the signal to be transmitted much farther, it would simply mean that these devices could be produced in very energy efficient models with an extended run time, between battery replacement or recharging, battery type and size would be made as an executive decision after proper power requirement assessments can be determined, in accordance with the principles of the present embodiment.

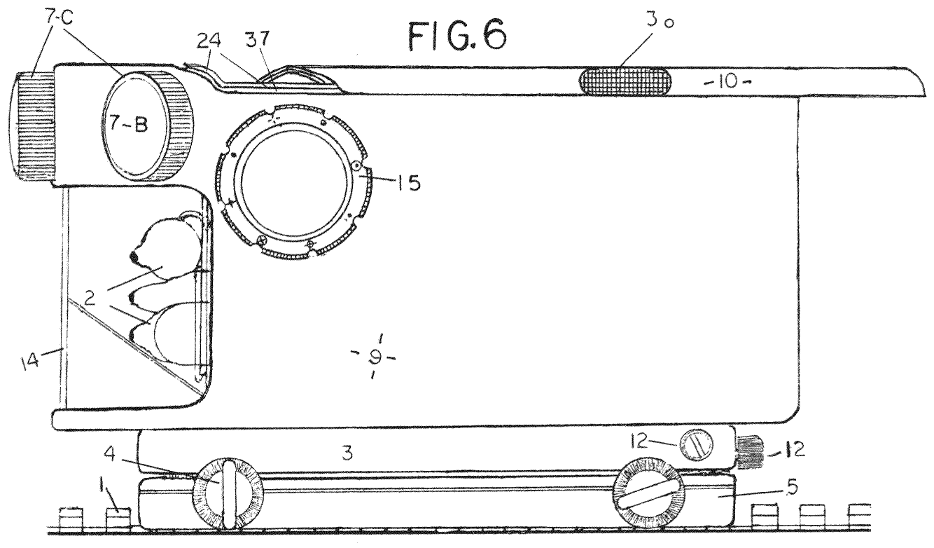

FIG. 6 is a profile view of the surveillance device in an embodiment taught herein. Infrared illuminator's lens housings 7-C and beam width adjustment knobs, which may be accomplished in an alternative manner, but these illustrations show these rotatable knob portions which would be O ring sealed but possess inner threads that thread onto outer threads on the light housings themselves, so that by means of rotation thereof, they adjust the distance between the light source and the lens on the infrared illuminators used to adjust beam width. An infrared illuminator's lenses 7-B is provided as well as the lid 10 to the battery compartment. The upper portion rail mount 3 is an integral component of the device's housing 9. The tensioning knobs 4 facilitate the attachment and disengagement of the rail mount to the mounting rail 5; this is one of several different types of quick release rail mounts. The textured and slightly raised portions of the sides of the battery compartment lid are to help facilitate the removal of same, in accordance with the principles of the present embodiment. The lid 10 to the battery compartment. This drawing shows the battery compartment lid slid back. Raised textured portions 38 of the side of this lid to help facilitate the lid's removal. This drawing shows this lid pulled back to an approximate point where the lid would have to be slid back to come out of its tracks for the lid's removal, as well as the removal or re-installment of battery pack, and this lid 10 is in a partially opened positioned where the upper lip, which is a latterly protruding portion 24 of the inset raised portion 37 for the lid 10; this latterly protruding portion 24 extends around and across the upper most forward and aft portions of the battery compartment and extends inward a short distance on the upper and outer most perimeter of the battery compartment creating a groove or dado and thus creating a track between the latterly protruding portions 24 of the inset raised portion 37 and the upper and outer most portion of the housing 9. Protruding inward from the outermost perimeter of the inside perimeter of the battery compartment lid 10 is an additional protruding portion creating male track sections, located in the same forward and aft portions, as well as extending a short distance approximately ¾ of an inch towards the center portion of the lid 10, as to match up and mate with the protruding portions 24 of track 37, creating an interlocking track so that by setting the lid on the top of the battery compartment in the same approximate location as illustrated or farther back, all one must do to attach and solidly latch the battery compartment lid to the top of the battery compartment is push the lid forward, sliding same into the interlocking track, and as the forward protruding portion of the lid reaches the forward raised portion of the upper perimeter of the battery compartment, it pops over same, latching same in place with the outer perimeter of the battery compartment lid remaining lower than the raised recessed portion and the uppermost portion of the protruding upper track portion of the battery compartment. This would also create a drip rail that would not only help seal the battery compartment lid 10 from contaminants but also keep moisture out. Then to remove the lid, one would simply grasp the sides of the lid by the textured handle portions 38 of the sides of the battery compartment lid and simply pull same straight back and reverse the installment, in accordance with the principles of the present embodiment.

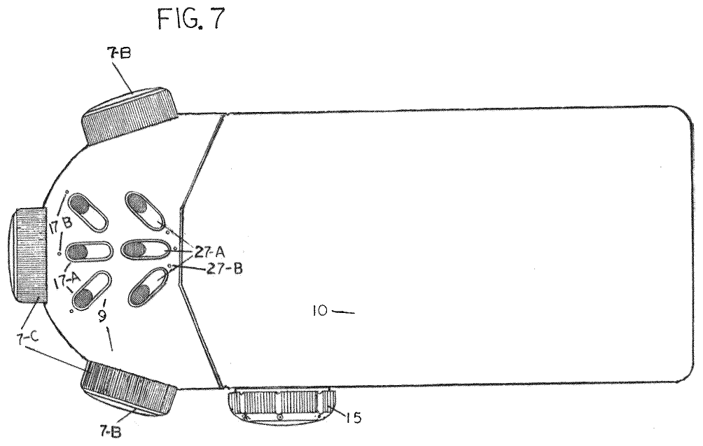

FIG. 7 is an overhead view of the surveillance sight with infrared illuminators incorporated into its housing 9 in an embodiment taught herein. Switches 27-A complete the circuit creating electrical communication between the batteries and the cameras 20 and 2. Switches 27-B complete the circuit and create electrical communication between the batteries and the infrared illuminators 7. The top portion 10 is the battery compartment lid, in accordance with the principles of the present embodiment.

### Firearm and Helmet Multi-Positionable Adjustable Smart Device Mounts

The present invention advantageously provides a tactical, and multi-positional smart device mount, for the attachment both to the mounting rails of helmets and firearms, to provide users with the perfect vantage point of target images and their surroundings of the users. This as well as to provide them with advanced knowledge of present and developing dangers while maintaining full accurate use of a firearm, and all while remaining totally behind protective cover while doing so and providing the transmitted or transferred images received by the cameras provided by surveillance sights to be viewed by the user in the digital display of a smart device. Accordingly, the components have been represented where appropriate by conventional symbols in the drawings, showing only those specific details that are pertinent to understanding the embodiments of the present invention so as not to obscure the disclosure with details that will be readily apparent to those of ordinary skill in the art.

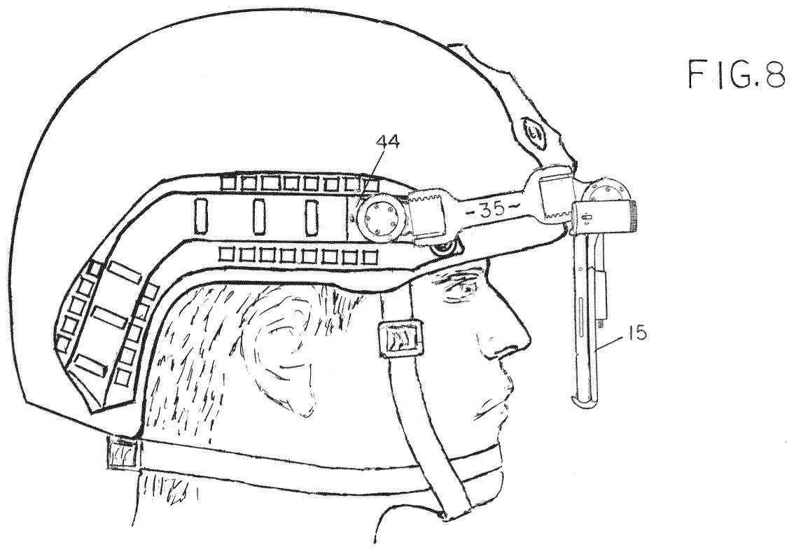

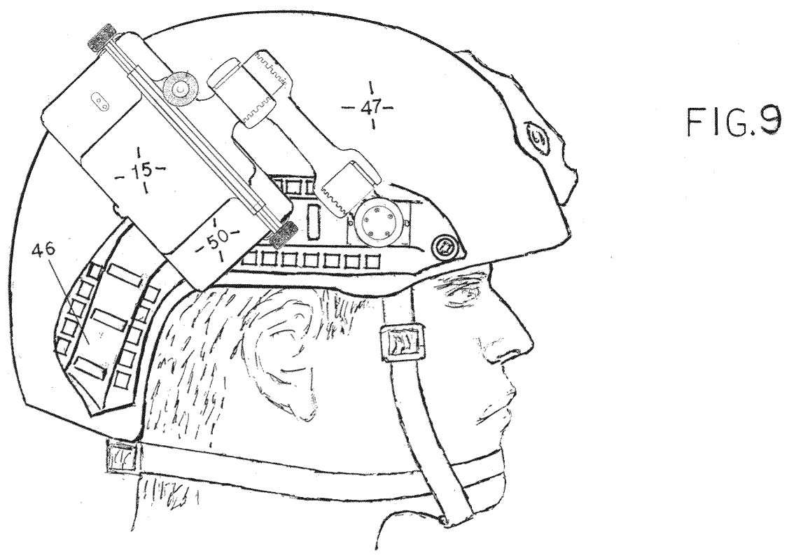

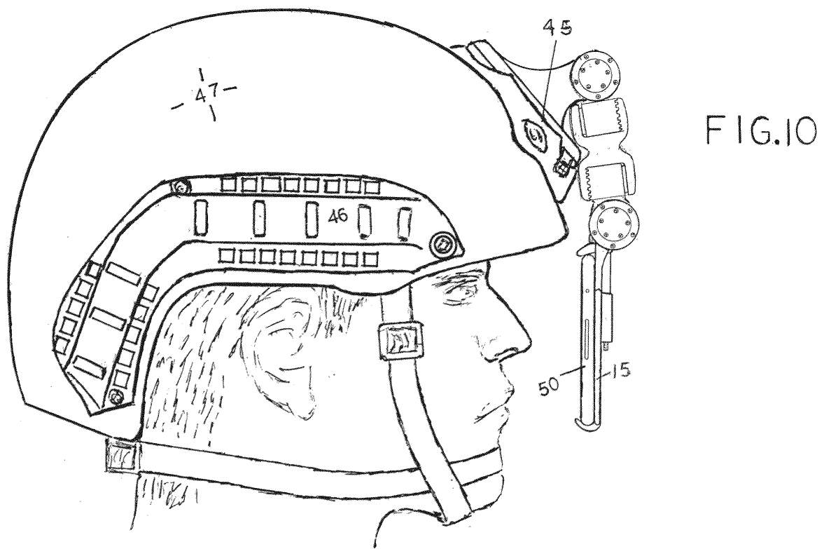

FIG. 8 is a profile view of the multi-position ably adjustable smart device mount consisting of a helmet side rail mounting base 44 as well as two rotate-ably position-able joints both integral to and separated by an armature 35. Both of these joints consist of two rotationally adjustable joints, that are both integral to each other. These rotatable and position-able joints being oriented in 90-degree opposition to each other, with the inner joint integral to the helmet siderail mounting base 44, and the outer joint integral to the actual multi-position ably adjustable smart device mount 15. These joints provide this smart device with not only extremely fast and easy angle adjustably, but almost limitless position-ability as well, in accordance with the principles of the present embodiment.

FIG. 9 is a profile view of the multi-position ably adjustable smart device mount 15 in a position of storage with the screen of the smart device 50 positioned face down up against the helmet 3. Although these two positions of adjustment, shown in FIGS. 1 and 2 are only two of various position options of vertical, horizontal or lateral, pivotal, or rotational desired position. The combination of these four multi-position ably adjustable joints provide the user with the ability to position of the smart device into any desired position of either deployment or non-deployment, weather mounted on either the side or the front of a helmet 47 in accordance with the principles of the present embodiment.

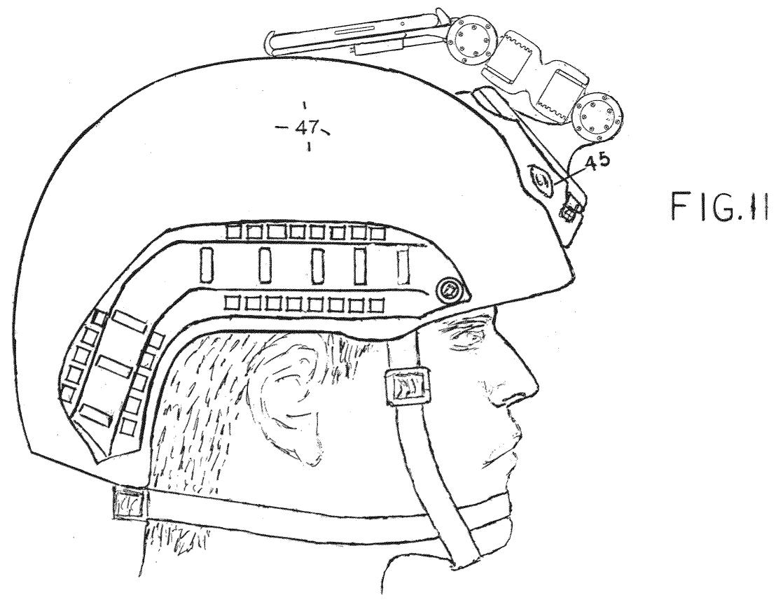

FIG. 10 is a profile view of a multi-position ably adjustable smart device mount in a position of employment, mounted and position-alley adjustable on the forward mounting base of a helmet 45, both of these base mounts could be made with either type of mount, and with the initial rotate ably adjust-able joint being either vertical or horizontal in relation to its mounting base, in accordance with the principles of the present embodiment.

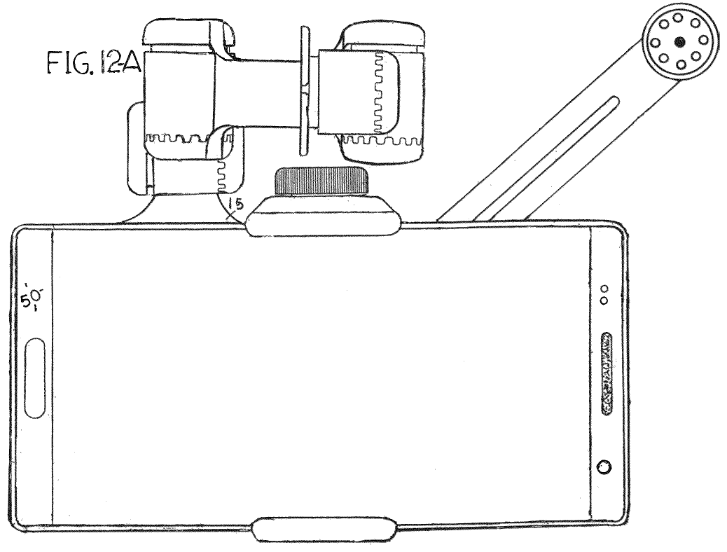

FIG. 11 is a profile view of the multi-position ably adjustable smart device mount that's mountable on the forward mounting base, in a position of storage or non-deployment, mounted on the forward mounting base 45 of a helmet 47 both the side and the frontal mounting multi-position ably adjustable smart device mounts could and may well be made as interchangeable simply by means of manufacturing the frontal portion of the mounting base manufactured with a very small portion of the same type of mounting rail as the side mounting rail, made as an integral upper portion of the mounting base 45 in accordance with the principles of the present embodiment.

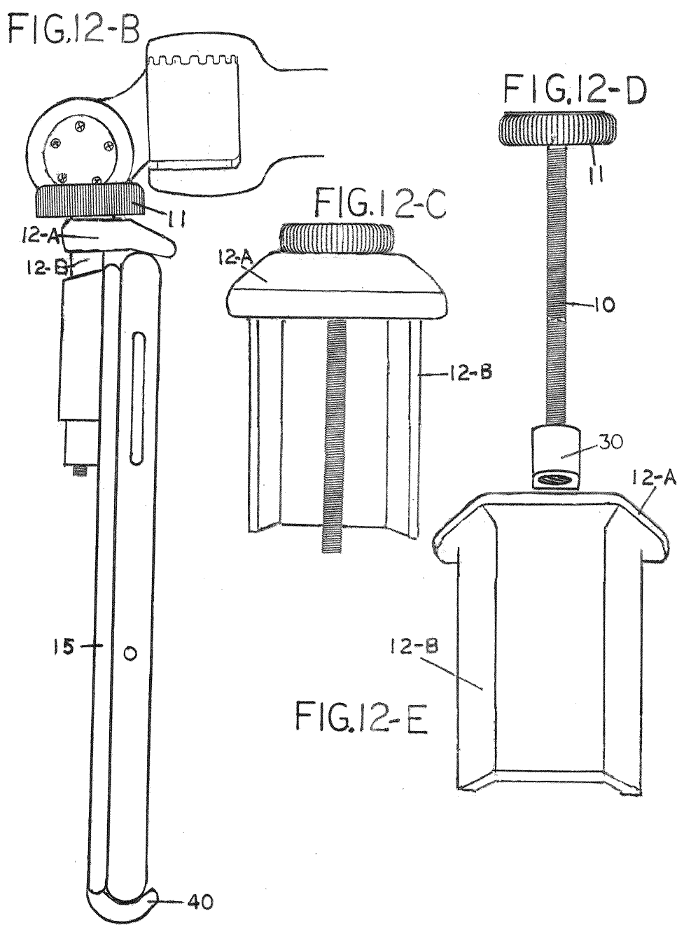

FIGS. 12-A through FIG. 12-E are drawings of the basic components of the first type of helmet mount able and multi position able smart device mounts. These mounts possess two sets of two rotationally adjustable joints, totaling four actual points of adjustability that are both integral to each other as well as an armature 43 that connects them together with on side of which integral to the smart device mount itself. And the other integral to the rail mount 44. These rotatable and position-able joints are all oriented in 90-degree opposition to each other, which provides each set of these joints, with both vertical and horizontal 360 degree adjustably. With two of these joints being a portion of the smart device mount itself. The other two rotatable and position-able joints are located at the opposite end of the armature 43 that's an integral portion of the helmet mount provides this mount with the same vertical and horizontal 360-degree adjustability's which multiplies the mounts position ability. This along with these joints engineering and mode of operation, provide the smart device mounts that are displaying the viewing screen of the smart device, with not only extremely fast and easy adjustably, but almost limitless position-ability of both deployment as well as in its optional positions storage or non-use. These joints not only very solidly lock into their various angels of rotational adjustment but desired adjustability is achieved with an extreme level of speed, ease and efficiency simply by means of applying pressure to the desired joint or combination of joints, in the direction that separates the interlocking teeth that extend around the perimeters of both the interlocking housing, and interlocking flange couplings, while simply positioning the smart device and mount into its desired position. Once the desired angle or position of adjustment is realized, the user simply releases the smart device and mount, which intern releases the internal springs located inside these joints and once again, re-compress ably secures these interlocking teeth into each other and very solidly locks the smart device and its mount into its desired position of adjustment.

FIG. 12-A displays a view of the multi-position ably adjustable smart device mount 15 and smart device 50 as it would be viewed by the user in its a position of employment, mounted and position-alley adjustable on the side mounting rail of a helmet, in accordance of the principles of the present embodiment.

FIG. 12-B is a profile view of the actual smart device mount portion of the multi-position ably adjustable smart device mount. These mounts their selves are actually illustrated in two optional types. This type of mount simply compress ably secures the smart device into a cradle 40 located and made as an integral portion of o the bottom of the smart device mounting base itself 15. By means of compression applied by 12 the upper smart phone or small tablet compression clamp pressure is applied and maintained by means of clock wise rotation of the thumb screw knob 11. This knob is an integral portion of a threaded rod 10 this rod actually threads through a threaded collet 30 that's actually a portion of the very top of the back side of the smart device mount 15 centered inside the top of the upper smart device compression clamp housing 12-B which is actually another portion of the smart device mount 15.

FIG. 12-B also illustrates the two forward rotationally adjustable joints, that are both integral to each other as well as to the smart device mount itself. These rotatable and position-able joints are oriented in 90-degree opposition to each other, which provides these joints, with 360 degree adjustably in 90-degree relation to each other. These two integral rotatable adjustable joints actually only being one of two sets of joints separated by an armature, integral to this mount 15 as well as its mounting base.

FIG. 12-C is a drawing of the inner portion of a component of one of the optional types of the actual smart device mounts. This being the upper clamping portion 12-A and 12-B of the mount that compress-ably secures the smart phone or smart device into its cradle 40 which is a portion of the bottom part of the smart device mount 15.

FIG. 12-D is a drawing of a thumb screw 11 and the treaded rod 10 integral to thumb screw #11 that extends through a hole in the upper portion of the upper clamping portion of the mount 12 viewable in FIG. 12-C the threaded portion of this thumbscrew 10 which intern threads through the threaded eyelet 30 which is actually a portion of the backside of the smart device mounting base 15. By means of rotation of this thumbscrew the smart device is both secured into and removed from the smart device mounting base 15.

FIG. 12-E is a drawing of the backside or outer portion of the clamping portion 12 of the mount that compress-ably secures the smart phone or smart device into its cradle, in accordance with the principles of the present embodiment.

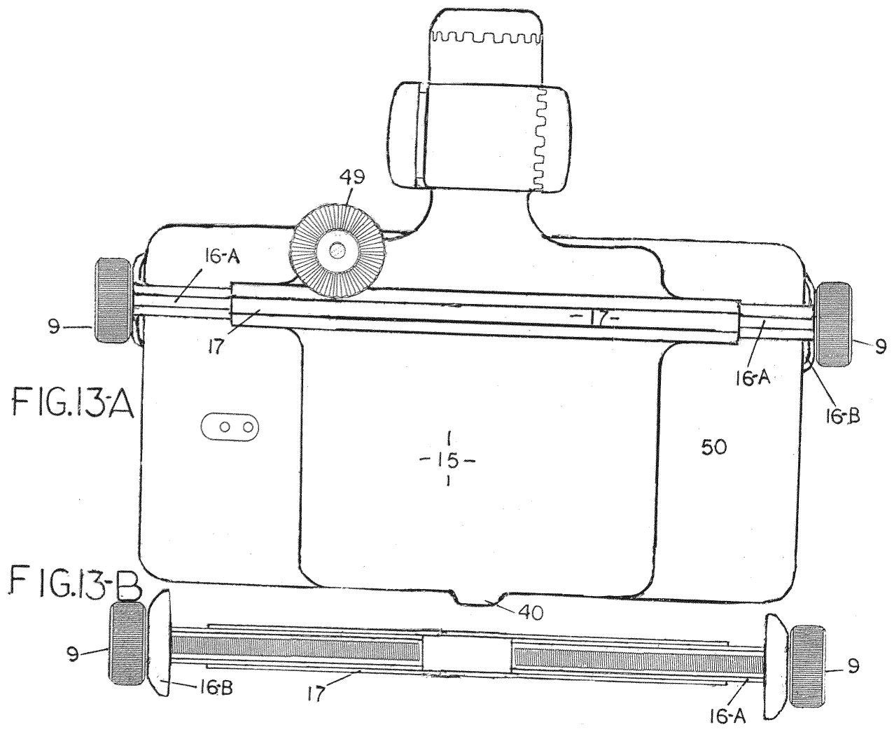

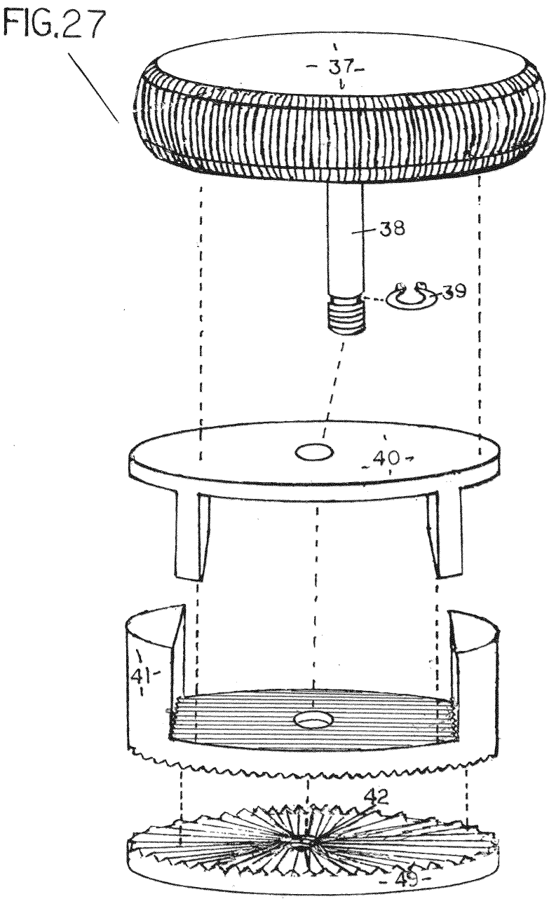

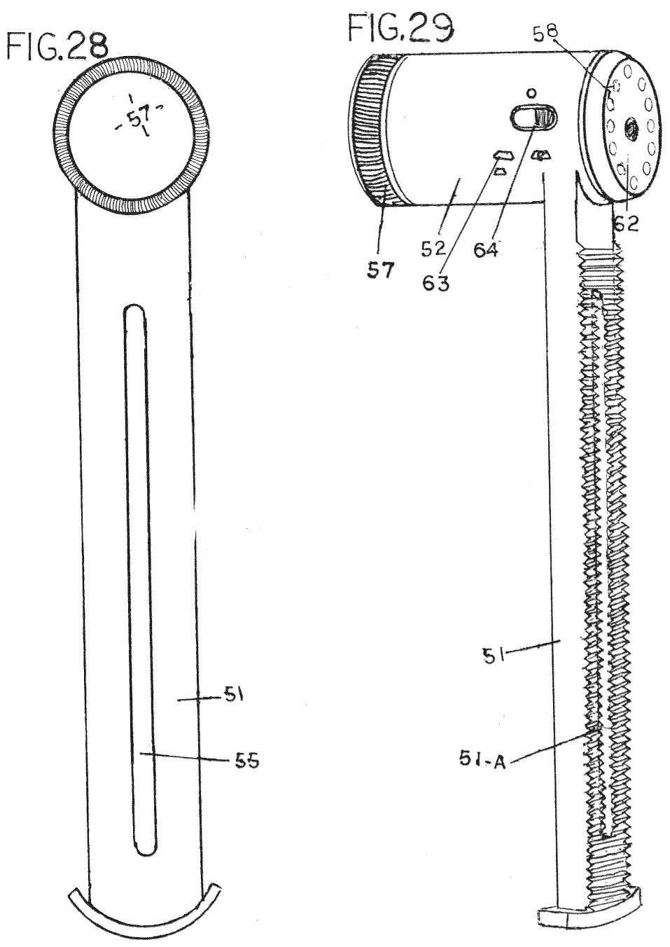

FIG. 13-A is a drawing of the backside portion of another optional type of multi-position ably adjustable smart device mounting base 15 this type of mounting base possesses a small cradle 40 that's also an integral portion of the bottom the lower center portion of the smart device mount, that the smart device actually rests in. this type of smart device mount compress ably secures the smart device onto the mount by means the compression clamp and slide 16-A and 16-B what are actually portions of the same component which is actually housed inside side compression clamps housing 17 which is actually a portion of the smart device mounting base 15 the smart device is secured to the mounting base by means of clock wise rotation of the thumb screws 9 the threaded rod of which threads through threaded collet 31 viewable in FIG. 13-D this collet is also a portion of the smart device mounting base 15 as illustrated in FIG. 13-C one advantage of this alternative smart device mount is that no smart device has ever been made with controls on the top or bottom edges. This simply meaning this mount itself like the others would never obstruct any controls on the smart device due to their positional locations. This as well as the mount actually more securely attaching the smart device to the mount in that the mount possess three points of securement rather than the two of the alternate type. This as well as with the removal of the smart device being very fast and easily accomplished by means of the loosening of just one of the lateral compression thumbscrew knobs 9. Without losing any preferred lateral adjustment of the smart devices positioning in the mount while doing so the mounting base 49 is a slightly raised, radially toothed mounting base, that's actually a portion of the smart device mount 15. This mounting base is for the attachment and positioning of a Hight and angularly position able rear viewing camera mount viewable in various FIGS. But illustrated and described in detail in FIG. 28 This mount mechanically fastens to the mounting base 49 by means of a centrally located and internally threaded portion of mounting base 49 this mount viewable in FIG. 27 compress ably secures an armature 51 viewable in FIGS. 28 and 29 which is integral to the rear viewing camera 52 also viewable in FIGS. 28 and 29 that is intern height and positionally adjustable therein.

FIG. 13-B is a drawing of the clamp housing 17 being the lateral slide clamp housing that would actually be manufactured as an integral portion of the smart device mount itself 15 this housing houses the lateral compression slides 16-A which are actually an integral portion of the lateral compression clamps 16-B which compress ably secures the smart device into the smart device mount 15 by means of clockwise rotation of the lateral thumbscrew knob 9 that a small ridge portion of the threaded rod of thumb screw 9 freely rides and is incased in the end portion of the lateral compression smart device clamps of 16-B the smart device clamp 9 the threaded rod.

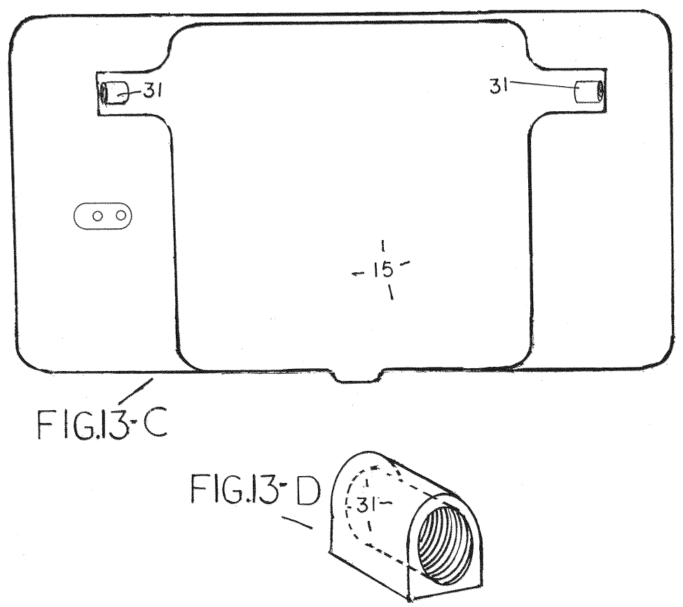

FIG. 14 is a profile view of the embodiment of the multi-position ably adjustable smart device mount locked into a position of employment, mounted on either the top or side mounting rails of the firearm 1. This mount possesses the ability to provide the user with the perfect vantage point of the smart device screen from any position in relation to the firearm. This due to the multiple angular adjustability, as well as the pivotably of this multi position-able firearm rail mountable version of this invention. Adjustment of these joints is simply and rapidly accomplished by means by means of a slight downward and rotational pressure, applied at the same time to the smart device or mount itself, which intern compresses the internal spring thereof, which intern disengages the interlocking teeth, for the horizontal rotational positioning thereof. The vertical rotational or angular positioning of this mount is also very simply and rapidly accomplished simply by means of a slight bit of lateral pressure applied to the smart device. Which compresses the internal spring this action intern disengages the interlocking teeth that solidly lock each joint into its desired position by means of a plurality of teeth that span from an inner portion of the joint out to the outer perimeter thereof progressively becoming wider as they extend outward, once this interlocking joints teeth are separated and the desired angle is realized the smart device and its mount is solidly relocked into its newly desired position of adjustment simply by means of releasing the pressure on the smart device and relocked solidly into its newly desired position. Providing the user to with one hand in accordance with the principles of the present embodiment.

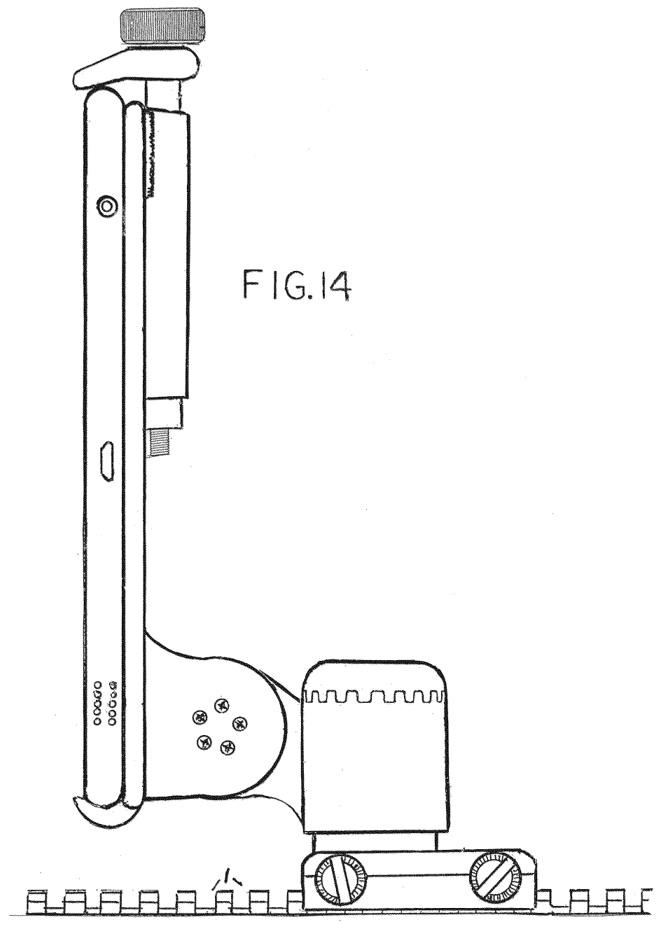

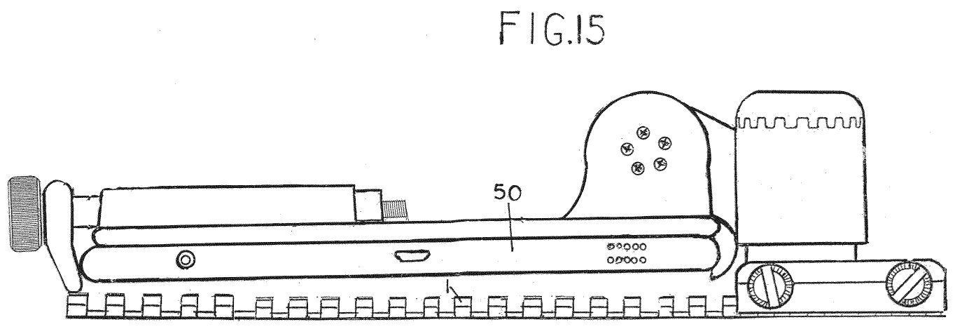

FIG. 15 is a profile view of the embodiment of the multi-position ably adjustable smart device mount that is mountable on either the top or side mounting rail of the firearm with the smartphone 50 and its mounting base 2 folded down and locked into its position of non-deployment.

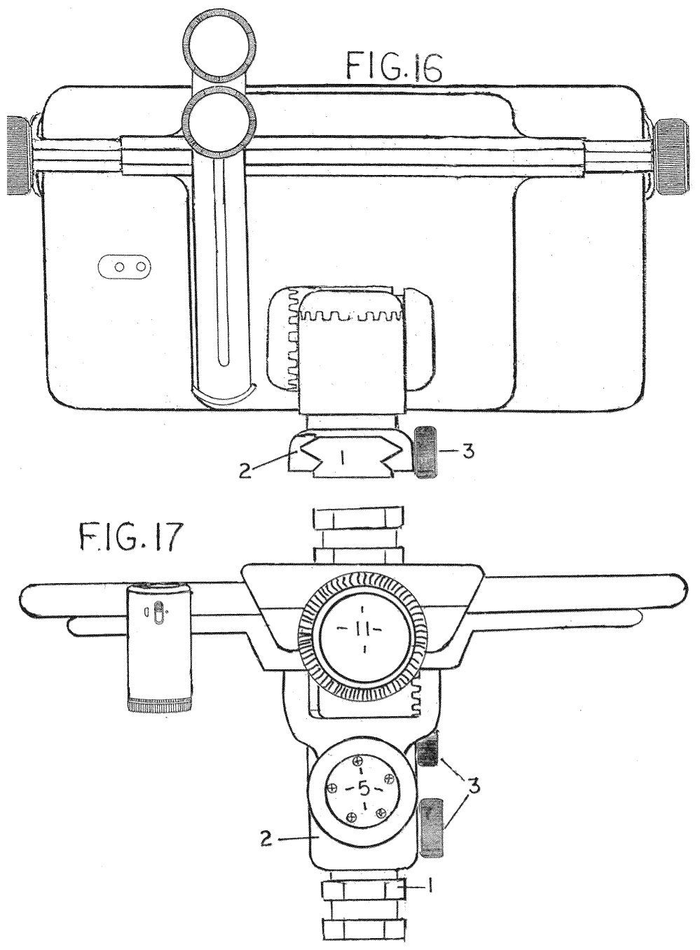

FIG. 17 is an overhead view of the embodiment of the multi-position ably adjustable smart device mount locked into a position of employment, mounted on either the top or side mounting rail 1 by means of its rail mount 2 this rail mount is illustrated as being secured to the rail by means of thumbscrews 3 which would be actually only one of many optional type of rail mounts employable which may or may not be employed. This device may be equipped with one of the many types of quick release mounts instead. In accordance with the principles of the present embodiment.

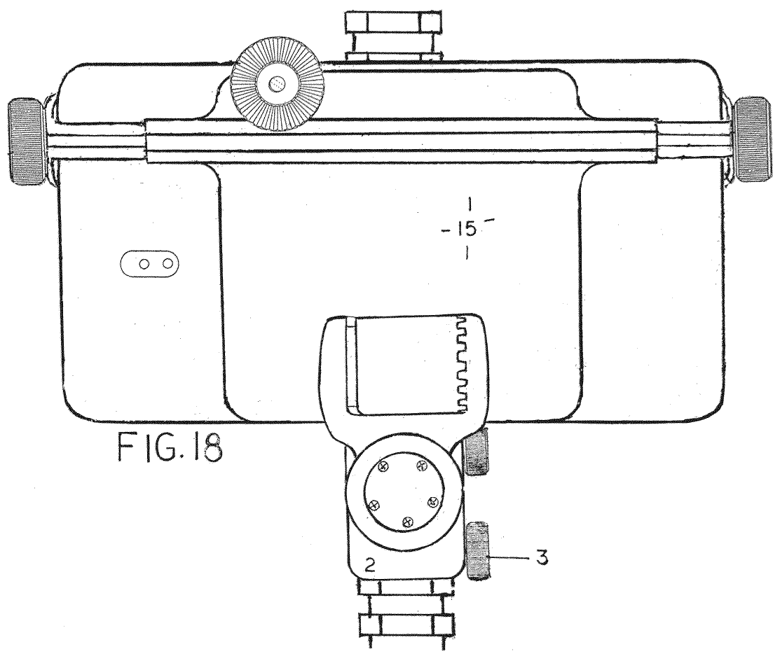

FIG. 18 is an overhead view of the embodiment of the multi-position ably adjustable smart device mount that is mountable on either the top or side mounting rail of the firearm with the smartphone 50 and its mounting base 15 folded down and locked into its position of nonuse. Where it can remain out of the way until needed where it can be quickly and easily re deployed by means of a bit of side pressure while re-vertically positioning in accordance with the principles of the present embodiment.

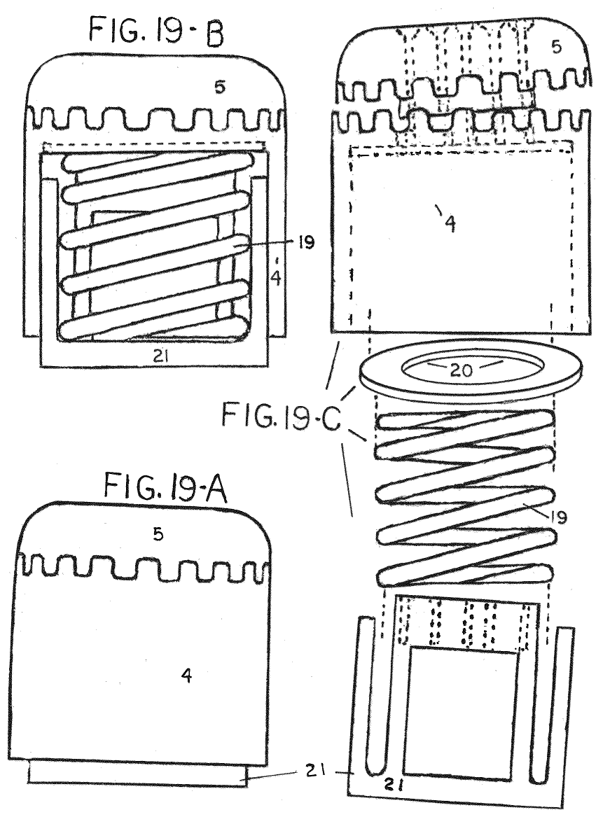

FIG. 19-A through FIG. 19-C are drawings of the mechanical breakdown of one the rotationally-position-ably adjustable joints, illustrated as being employed as the initial or base rotationally-position-ably adjustable joints, employed as the first integral portion of the inventions base mount, that would be made as a portion of a either a helmet or firearms rail mount, or alternately as a forward helmet mounting base that locks into the helmets forward goggle or night viewing base mount. This joints housing 4 would actually be made as an integral portion of an additional multi-position ably adjustable joint, not shown. Although any types of these joints would work equally as well in any combination, application, or angel in combination with each other and integral to each, and with their multi-position adjustable portions, in 90-degree opposition to each other intern provides this device with full both 360-degree position adjustability from four points of adjustment both vertically and horizontally. Their being employed in any combination intern provides these devices with their almost countless optional of position ability.

FIG. 19-A is a drawing of the one of the multi-positionably adjustable joints, illustrated as being employed as the initial or base multi-position ably adjustable joints, that are employed as the first integral portion of the inventions, made as a portion of the rail or base mounts. This multi-position ably adjustable joints housing 4 would actually be made as an integral portion of an additional multi-position ably adjustable joint, described in detail in FIG. 20.

FIG. 19-B is a drawing of the one of the multi-position ably adjustable joints as if the outer housing of which was transparent so the inner workings where viewable, this type of these joints have all been illustrated as being employed as the initial or base multi-position ably adjustable joints, or as those employed as the first integral portion of the inventions connected to the rail or base mounts. This multi-position ably adjustable joints housing would actually be made as an integral portion of an additional multi-position ably adjustable joint, not shown.

FIG. 19-C is a is a drawing of a dissembled and blown up view of one of the multi-position ably adjustable joints, this type of these joints are all illustrated as being employed as the initial or base portion of the multi-position ably adjustable joints, or as those employed as the first integral portion of the inventions integral to the rail or base mounts. This rotationally position-ably adjustable joints housing 4 would be made as an integral portion of an additional rotationally position-ably adjustable joint. The combination of which, making a multi-position able joint. The housing portion of this joint as well as all of its internal components are exactually the same in both embodiments of these rotationally position-able joints and both function in the exact manner. The top portion of which possessing a plurality of teeth that span from an inner portion of this inter locking joint out to the outer perimeter thereof progressively becoming wider as they extend outward to the outer periphery portion of the top and bottom portions this joint. These interlocking teeth consist of both male and female portions the inner sides of which are very slightly mitered in a manner that these teeth tightly and solidly lock into each other by means of a spring 19 located in an inner portion of the housings 4 of each joint this spring both compress-ably and solidly locks the male portions of these teeth into their female portions after rotational adjustment. Of each of these rotationally position-able joints is completed. This same spring also provides the user with the ability to change the vertical and horizontal rotational adjustment of these joints at will simply by means of applying compressible pressure to the smart device mount or armature in the direction that compresses the internal spring that intern separates the male teeth from their female interlocking teeth, at which time positional adjustment of same is accomplished by means rotating the smart device mount to its desired position of vertical or horizontal rotation, then simply by means of releasing the presser compressing the internal spring, this same spring re compress-ably and solidly relocks the slightly tapered or mitered teeth back into each other as well as the smart device and mount or armature into its newly desired position of adjustment with one quick and easy fluid motion. The inside surface of housings 4 slides up and down as well as rotates on the outer surface of the rotationally positionable joint 21. Both of these surfaces are very smooth and are made with very close tolerances to each other. Inside the housing 4 of this rotationally position-ably adjustable joint contains a friction washer 20 usually made of thin very smooth high tempered steel, and actually more than one of these friction reduction washers may be employed this washer or washers are housed inside a milled out upper inside inset portion of housings 4. Directly under the friction reduction washer is a spring 19 this spring fits inside the lower portion of this rotationally position-able joint 21, inside a milled-out portion thereof between the inside surface of the outer portion of the rotationally position-able joint 21 and the outside surface of the inner portion thereof. The top surface portion of the rotationally position-able joint 21 is intern mechanically fastened to the lower surface of the upper portion of this joint 5 by means of mechanical fasteners or machine screws that extend through the upper portion of 5, of this joint, and solidly fastens these two portions of this joint together, as seen in FIG. 19-B.

FIG. 20-A through FIG. 20-E are drawings of the inner workings and components of the second type of these rotationally position-able joints, which in this application is made as an integral portion of the multi-position ably adjustable joint, either of this same type or of the type seen in FIG. 19.

FIGS. 20-A and 20-B are drawings of the inner workings and components that solidly lock into the outer portion of this rotationally position-able joint, that in these applications, the combination of which, would also all actually be made as an integral portion of an additional rotationally position-ably adjustable joint, that intern would become a multi-position ably adjustable joint. This portion of this joint is constructed much in the same manner as that of the rotationally position-able joint seen in FIG. 19 in that this rotationally positionally adjustable joints housing portion as well as all of its internal components are exactually the same in both embodiments of these rotationally position-able joints and both function in the exact manner. The top portion of which possessing a plurality of teeth that span from an inner portion of this inter locking joint out to the outer perimeter thereof progressively becoming wider as they extend outward to the outer periphery portion of the top and bottom interlocking portions this joint. These interlocking teeth consist of both male and female portions the inner sides of which are slightly mitered in a manner that these teeth tightly and solidly lock into each other when their compress ably locked into each other by means of a spring 19 located in an inner portion of the housings #4 of each joint this spring both compress-ably and solidly locks the male portions of these teeth into their female portions after rotational adjustment. Of each of these rotationally position-able joints is completed. This same spring also provides the user with the ability to change the vertical and horizontal rotational adjustment of these joints at will simply by means of applying compressible pressure to the smart device mount or armature in the direction that compresses the internal spring 19 that intern separates the male teeth from their female interlocking teeth, at which time positional adjustment of same is accomplished by means rotating the smart device mount to its desired position of vertical or horizontal rotation, then simply by means of releasing the presser compressing the internal spring, re compress-ably and solidly relocks the slightly tapered or mitered teeth back into each other as well as the smart device and mount or armature into its newly desired position of adjustment with one quick and easy fluid motion. The inside surface of 4 slides up and down as well as rotates on the outer surface of the rotationally position-able joint 22. Both of these surfaces are very smooth and are made with very close tolerances to each other. Inside the housing 4 of this rotationally position-ably adjustable joint contains a friction washer 20 usually made of thin very smooth high tempered steel, and actually more than one of these friction reduction washers may be employed this washer, or washers are housed inside an upper inside inset portion of the housing 4. Directly under the friction reduction washer is a spring #19 this spring fits inside the lower portion of this rotationally position-able joint 22, inside a milled-out portion thereof between the inside surface of the outer portion of the rotationally positionable joint 22 and the outside surface of the inner portion thereof. The top surface portion of the rotationally position-able joint 22 is mechanically fastened to the slightly extended lower surface of the upper portion of one side of this joint 7 by means of mechanical fasteners or machine screws that extend through one of the outer portions of this joint, and solidly fastens the first side these two portions of this joint together, the opposite side of the rotationally position-able joint 22 is fastened to the opposite side of joint 7 in the same manner by means of mechanical fasteners or machine screws that extend through one of the outer portion of joint 7, and thread into, and solidly fastens the second or base portion of the rotationally position-able joint 22 into opposite side of joint 7 and intern unitizing these two portions of this joint together as seen in FIG. 20-C the center portion of joint 7 would be optionally made as an integral portion of either the smart device mount, the armature portion of the helmet mount version of this device, or as an integral portion of an optional design of any of the rail or helmet mounts, or as the integral portion of the joint connecting the other position ably adjustable joint.

FIG. 20-C Is a drawing of a completely assembled second type of these rotate ably adjustable joints inner workings and components of the of these multi-position ably adjustable joints that would also all actually be made as an integral portion of an additional multi-position ably adjustable joint, the two of which comprising a multi-position-able joint. The housing of this joint is illustrated as transparent so the inner workings of which can be viewable as assembled. In accordance with the principles of the present embodiment.

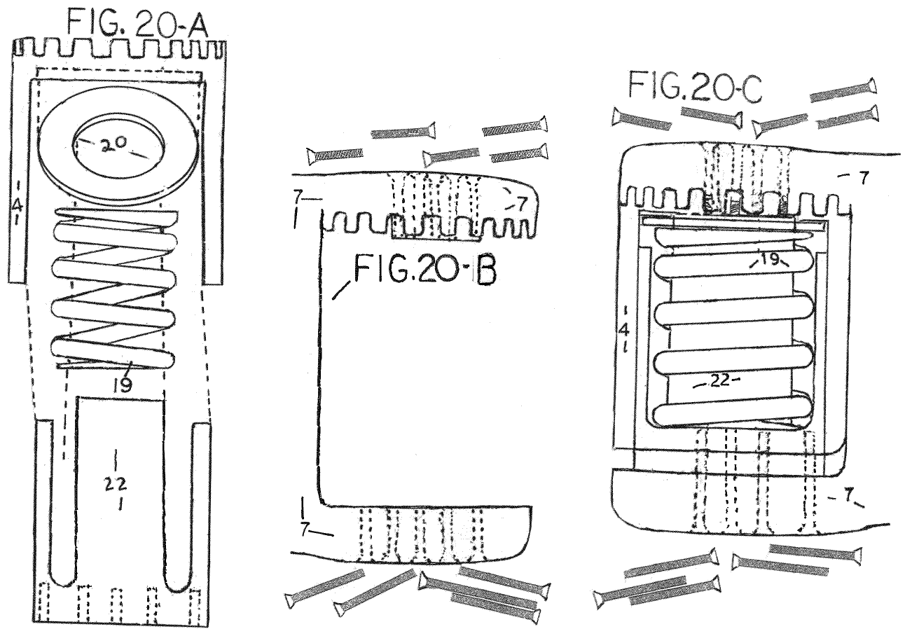

FIG. 21-A is a profile view of the basic components of the helmet mounts and illustrated as if the components inner two joints housings where transparent to view the inner workings thereof. Notice the helmet mounts as illustrated, are different than the firearm mounts in that the helmet mounts possess two sets of these double 360-degree positionally adjustable joints, connected by and integral to an armature, with both of these joints, providing 360-degree position adjustability in two access of rotation being 90-degrees in relation to each other. This providing 360-degree both horizontal and vertical adjustability, with one set of these joints integral to the Helmet mount, and with the other integral to the smart device mount itself, provides the user with this with both connected by and integral to an armature, which intern provides these multi position-able smart device mounts with both a full range of horizontal and vertical adjustability, at both the mounting base of the device, as well as at the smart device mount itself. This provides the user with a full and perfect applicable range of serviceable positional options of adjustability full range of service they provide in their own applications both in that of deployment as well as in that of storage or non-deployment.

FIG. 21-B is an overhead view of the basic components of the helmet mounts viewable from a position of 90-degrees in relation to that of the drawings of FIG. 21-A and also illustrated as if the outer components of the joints where transparent to view the inner workings thereof.

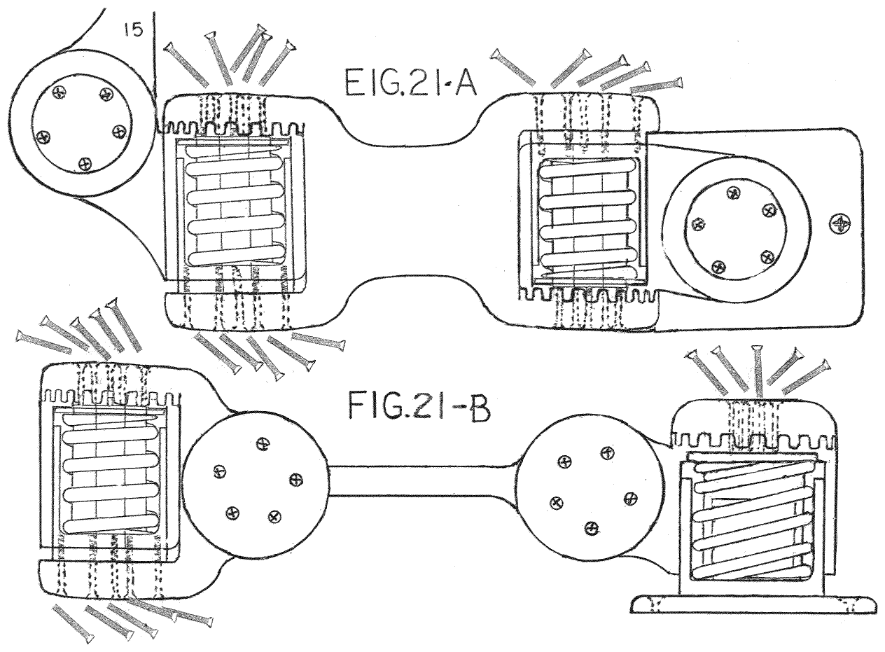

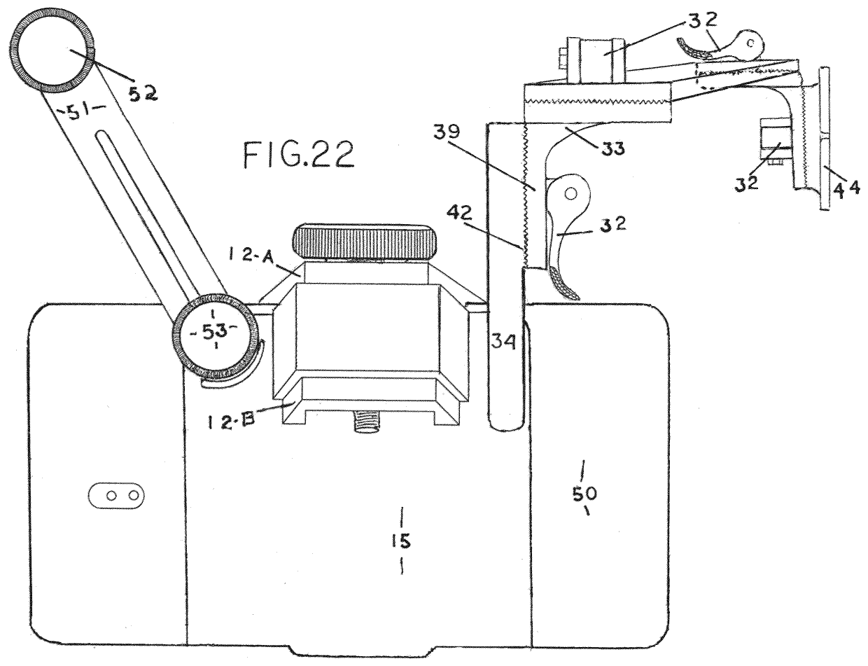

FIG. 22 is a drawing of a frontal view of the firearm mountable version of the multi position-ably adjustable smart device mount. This mount employs another optional type of rotate-ably adjustable joints made as an integral portion of a rail mount this optional type of joint also solidly lock each joint into its desired position by means of a plurality of teeth 39 that span from an inner portion of both parts of these joints to the outer perimeters thereof, progressively becoming wider as they extend outward. This type of multi-positional joints provides users with the same basic range of position-ability as the alternate type, but are just of a much more simplistically devised, and are positionally adjustable in a completely different manner. This type of joint compress-ably locks these teeth solidly together by means of a finger pull 37 this finger pulls base portion is pivotably secured to a post 39 by means of a smooth shanked machine screw or alternately by means of a press pin. These posts are located at the center of one side of each rotatable position-able joint. The base portion of these finger pulls are basically cylindrical in shape, but slightly egg shaped that progress-ably becomes larger on one side thereof and compress-ably secures and locks these teeth 42 into each other when these finger pulls are pressed in that the base of these finger pulls are larger on one side than the other, so that when rotated in towards the outer surface of the mount this compress-ably secures the interlocking teeth of the upper and lower portions of these joints solidly together. This type of joint is once again disengaged and re positionally adjustable, when the finger-pull 32 is repulled. These joints are all comprised of both a 90-degree portion 33 the outer surface of which possessing interlocking teeth that the position-ably adjustable portions of this embodiment are attached to and positionally adjustable off of weather the mounting base 43, the armature 35 smart device mount itself 15. This drawing also shows the rear viewing camera 52 as well as its mounting base 53 that provides the user with the ability to position-ably adjust the both multi position-able armature 51 and the rear viewing cameras height as well as its lateral position to acquire the cameras best vantage point of the aria behind the user.

FIG. 23 is a drawing of a frontal view of the side mountable version of the multi-position ably adjustable smart device mount 15 that employs the other optional type of rotate-ably adjustable joints. From a position in front the firearms mounting rail. This embodiment of this multi-position-ably smart device mounts drawing shows the rear viewing camera portion of this embodiment locked down solidly into its position of non-deployment. Mounting rail 1 of the firearm an optional type of the rail mount 2 that mechanically secures the multi-position-ably adjustable smart device mount securely to the mounting rail 1 of the firearm is illustrated.

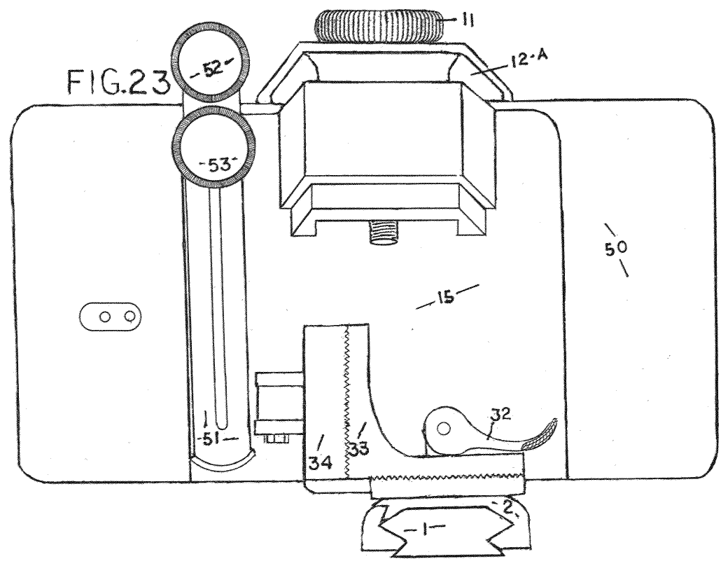

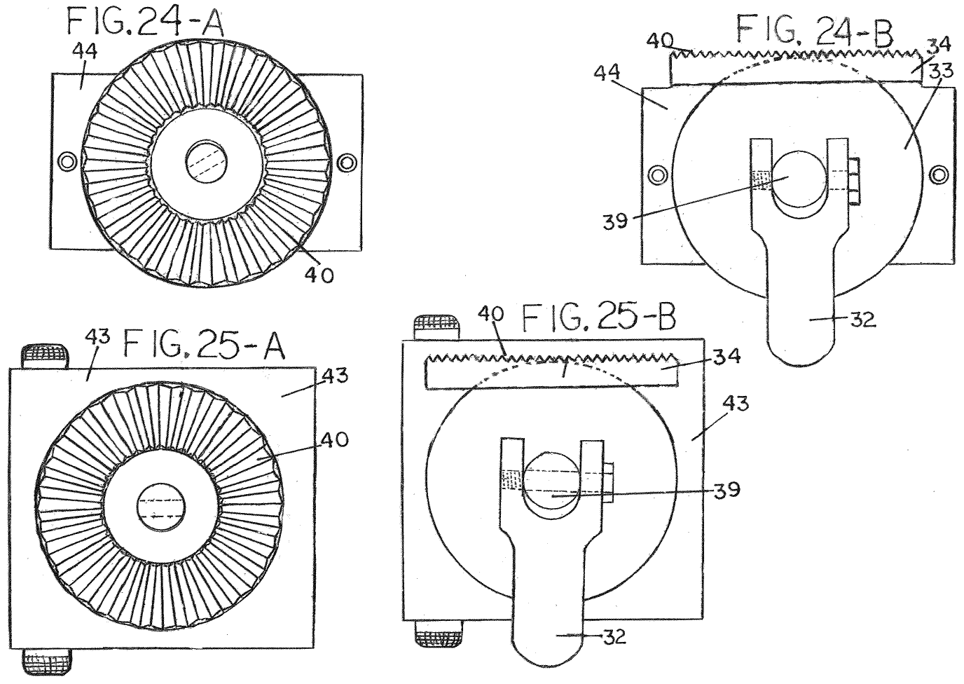

FIG. 24-A is a drawing of the mounting base portion of the side mountable helmet mountable version of the multi-position ably adjustable smart device mount that employs another optional type of rotate-ably adjustable joint. This portion of the base includes a post that the upper portion of this joint consisting of two plates 33 integral to and in 90-degree relation to each other, with interlocking teeth 40 as a portion of the outer surface portions thereof. A hole located in the center of one of the plate 34 rides on the post 39 of mounting base 44 of which the finger pull 32 attaches to and pivots on and compress ably secures and locks the rotatabley position able plate portions of the joints together.

FIG. 24-B is a drawing of an assembled mounting base portion of the side mountable helmet mountable version of the multi-position ably adjustable smart device mount that employs another optional type of rotate-ably adjustable joint. The operational mode and mechanical composition described in the definition of 24-A. And consisting of the same basic components.

FIG. 25-A is a drawing of the mounting base portion of the front helmet mountable version of the multi-position ably adjustable smart device mount that employs another optional type of rotate-ably adjustable joint. With the only real differences between this mount and the side mountable base being its basic mode of attachment as well as its size and shape as seen in FIGS. 24A and 24B, this in turn this mount like the helmet mounts in its first embodiment this mount could be easily made in one interchangeable configuration with two optional mounting basses, simply by making one of the basses attachment plat portion of the mount 90-degrees in relation to the mounting base, in accordance with the principles of the present embodiment.

FIG. 25-B is a drawing of an assembled mounting base portion of the front mountable helmet mountable version of the multi-position ably adjustable smart device mount that employs another optional type of rotate-ably adjustable joint. The operational mode and mechanical composition of which also being the same as that of described in the definition of 24A in accordance with the principles of the present embodiment.

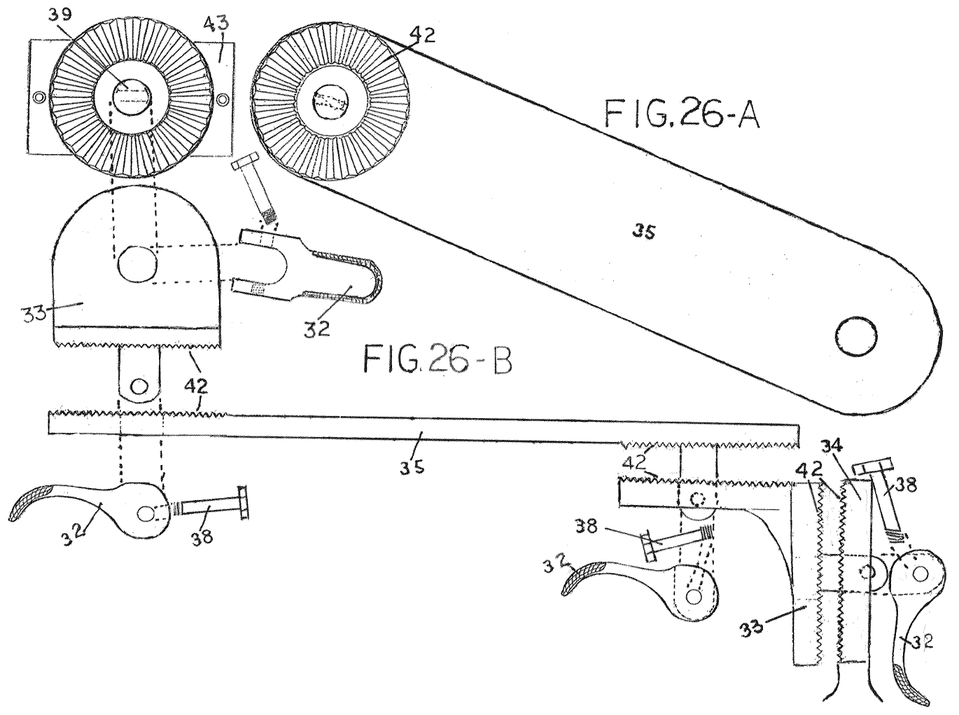

FIG. 26-B is a blown-up view of the side or front helmet mountable version of the multi-positionable, adjustable smart device mount that employs the another or optional type of rotate-ably adjustable joint. FIG. 26-A shows an additional top view of the armature 35 for same, in accordance with the principles of the present embodiment. This mount employs another optional type of rotate-ably adjustable joints made as an integral portion of a rail mount this optional type of joint also solidly lock each joint into its desired position by means of a plurality of teeth 39 that span from an inner portion of both parts of these joints to the outer perimeters thereof, progressively becoming wider as they extend outward. This type of multi-positional joints provides users with the same basic range of position-ability as the alternate type, but are just of a much more simplistically devised, and operate in a completely different manner. This type of joint compress-ably locks these teeth solidly together by means of a finger pull 32 this finger pulls base portion is pivotably secured to a post 39 by means of a smooth shanked machine screw or alternately by means of a press pin. these posts are located at the center of one side of each rotatably position-able joint. The base portion of these finger pulls are basically cylindrical in shape, but slightly egg shaped that progress-ably becomes larger on one side thereof and compress-ably secures and locks these teeth 42 into each other when these finger pulls are pressed in that the base of these finger pulls are larger on one side than the other, so that when rotated in towards the outer surface of the mount this compress-ably secures the interlocking teeth of the upper and lower portions of these joints solidly together. This type of joint is once again disengaged and re positionally adjustable, when the finger pull 32 is repulled. These joints are all comprised of both a 90-degree portion 33 the outer surface of which possessing interlocking teeth that the position-ably adjustable portions of this embodiment are attached to and positionally adjustable off of either the mounting base 43, the armature 35 smart device mount itself 15.

FIG. 27 is a blown-up view of rear viewing position adjustable camera mount. the multi-position-able camera mounting base 49 would be made as an integral portion of these multi-position-able mounts as well, in that they were also devised to employ this very same rear viewing camera mount and camera) The tensioning knob 37 is an integral portion of the threaded rod 38 which comprises a smooth upper section that turns freely through the upper clamping portion 40 then through the open slot portion 55 of the rear viewing camera armature 51 then through the lower jaw or clamping portion 41 an then is threaded into the threaded mounting base 42 which is actually an integral portion of the back side of the multi-position-able smart device mounts.

The assemblage of this unit as well as its mode of operation, is as follows. First the threaded rod 38 is inserted through a hole in the center of the upper section of the platform of the upper jaw clamp 40 it is then inserted through, a slot located in the center of the rear viewing camera armature 51 this rod 38 is then inserted through hole in the center of the lower section of the platform of jaw clamp 41 the bottom of which actually being the top portion of the rotationally position-able base of this mount. After insertion of the threaded rod 38 is inserted through all of these components, the C clip 39 is inserted into the groove located between the smooth part of the upper section of threaded rod 38 and the bottom threaded section of rod 38, locking all of these parts together. This C clip is housed in an inset section that extends around the outer perimeter of the bottom of hole, located in the center of lower rotationally position-able jaw portion 41. This inset C clip allows the loosening of the mount as the C clip 39 can travel inside inset area while loosening or tightening, while maintaining the assemblage of the rotationally adjustable mount to the camera and armature 51, so that this device can be removed from multi-positionally adjustable smart device mount and stored when not in use, then simply attached as a complete unit for deployment. Then the threaded end of rod 38, being an integral part of tensioning knob 37, is threaded into its mounting base 42, which is an integral portion of the multi-position-able smart phone or smart device mount, so that as knob 37, integral to threaded rod 38 is rotate ably threaded into its base 42, the camera armature 52 can be extended, rotated and locked into its desired height and lateral position to acquire the best vantage point, while completing this process the raised ridges or teeth located on the upper platform of the base 39 are locked into their corresponding lower grooves or notches between the raised teeth or ridges located on the lower platform surface of the rotate ably adjustable lower jaw portion of the lower jaw clamp 41 compress-ably lock into the raised teeth portions 51-A of the bottom side of rear viewing camera armature 51 and thusly as tension adjustable knob 107 is rotate-ably tightened the rear viewing multi-position able camera armature is compress ably secured between upper platform section of jaw-clamp 40 and the lower platform portion of the lower jaw clamp 41 this intern providing desired position-ability to the rear viewing Camera 52 being an integral part of the multi-positionally adjustable armature 51 which can be repositioned or returned to its position of non-use in the same manner by simply loosening the tensioning knob 37. Then returning the armature and rear-viewing camera thereon to its desired position and re-tightening knob 37, note this rear-viewing camera image is also viewable in the screen of the smart device either separately or simultaneously with the other targeting and surveillance cameras. in accordance with the principles of the present embodiment.

Now referring to FIG. 28 which is a drawing of a rear view of the rear viewing camera and camera housing 52, as well as armature 51, that would be an integral part of each other the camera housed therein of a type that both possess inferred viewing abilities so that when working in conjunction with its own, separately mounted or attachable infrared illuminator the image this camera provides to the smart phone or smart device to be viewed in the screen thereof, possess night viewing abilities, as does the camera's images provided by the targeting and surveillance cameras employed by various types of surveillance sighting devices, previously invented by the applicant for our military, that these multi-position-able smart device mounts and rear viewing cameras work in conjunction with. The combination of which predicted to prevent a large percentage of U.S. casualties. in that they provide the troops with the perfect vantage point of the surveilled images displayed in the screen of the smart device from any position the user has to position himself, to remain totally behind protective cover while doing so in accordance with the principles of the present embodiment.

Now referring to FIG. 29 which is a drawing of a slightly off-skew profile view of the rear viewing camera with an infrared illuminator 58, located just inside and illuminating through the camera's viewing window. The tiny led infrared lights making up the infrared illuminator, digitally spaced around the outer periphery of the inside portion of the camera's viewing window inside the camera housing 52, as well as its armature 51 that would be an integral part of the camera. This infrared viewable camera housed inside camera housing 52 receives its surveilled image through window 62, located in the very forward part of camera housing 52. A battery compartment located in an aft portion of camera housing 52, houses battery or batteries providing power for the cameras, image transference as well as an integral inferred illuminator if employed. Optional external types of employable inferred illuminators whether led or laser illuminators, would be either optionally attachable to the rear viewing cameras housing itself, or separately mountable. A watertight lid 57 to the battery compartment which simply provides access to the power supply for the removal and reinstallation of new or recharged batteries. A charging port 63 is also illustrated to optionally recharge the batteries therein. A switch and indicator light 64 is supplied to provide electrical communication between the battery or batteries and the camera receiving the image as well as to power image transference between the camera and the smart device displaying the cameras surveilled image. An additional switch would be supplied to provide electrical communication between the battery or batteries if an internal inferred illuminator is employed.

What is claimed is:

1. A firearm surveillance sight system, comprising:
a sight comprising a plurality of adjustably mounted cameras configured to provide a view via one or more smart devices of an environment surrounding a user, the sight adjustably mounted to a mounting rail of a firearm, and each of the one or more smart devices adjustably mounted to the mounting rail of the firearm or a helmet mounting rail positioned on a helmet of the user.

2. The system of claim 1, wherein the plurality of adjustably mounted cameras is disposed in a housing.

3. The system of claim 2, wherein one of the plurality of adjustably mounted cameras is a forward-mounted camera including a viewing window to permit the user to visualize a target.

4. The system of claim 3, wherein the viewing window permits the user to visualize a reticle displayed on a partially reflective inside surface of the viewing window.

5. The system of claim 4, further comprising a reticle selector provided on the housing to permit the user to select the size, shape, and intensity of the reticle.

6. The system of claim 1, further comprising one or more infrared illuminators positioned on the sight.

7. The system of claim 1, wherein the one or more smart devices are adjustably mounted via a first joint and a second joint separated by an armature, wherein the inner joint is integral to the mounting rail of the firearm or the helmet mounting rail, and wherein the outer joint is integral to a smart device mount.

8. The system of claim 1, further comprising a power source disposed in the housing, the power source in electrical communication with the sight.

9. A firearm surveillance sight and mounting system, comprising:
a sight comprising a plurality of adjustably mounted cameras disposed in a housing, the plurality of adjustably mounted cameras arranged to provide at least a 270° view of an environment, the sight adjustably mounted to a mounting rail of a firearm;
one or more smart devices in operable communication with the sight to provide an electronic display of the at least 270° view of the environment, and each of the one or more smart devices adjustably mounted to the mounting rail of the firearm or a helmet mounting rail positioned on a helmet of the user.

10. The system of claim 9, wherein one of the plurality of adjustably mounted cameras is arranged in a forward-mounted position to view a forward reticle and the environment in front of the user via a viewing window.

11. The system of claim 10, wherein the viewing window permits the user to visualize a reticle displayed on a partially reflective inside surface of the viewing window.

12. The system of claim 11, further comprising a reticle selector provided on the housing to permit the user to select the size, shape, and intensity of the reticle.

13. The system of claim 12, wherein the reticle selector is a rotational adjustment knob.

14. The system of claim 13, wherein one or more of the plurality of adjustably mounted cameras is a rear-viewing camera to view the environment behind the user.

15. The system of claim 14, wherein the smart device displays an unobstructed 360° view of the users environment.

16. The system of claim 15, wherein the smart device facilitates magnification of the displayed environment.

17. The system of claim 9, wherein the one or more smart devices are adjustably mounted via a first joint and a second joint separated by an armature, wherein the inner joint is integral to the mounting rail of the firearm or the helmet mounting rail, and wherein the outer joint is integral to a smart device mount.

18. The system of claim 18, wherein the sight is in operable communication with one or more firearm accessories.

19. The system of claim 9, wherein the sight and the one or more smart devices are each in electrical communication with at least one power source.

20. A firearm surveillance sight system, comprising:
a sight comprising a forward-mounted camera and one or more peripheral cameras, the sight adjustably mounted to a mounting rail of a firearm;
one or more smart devices in operable communication with the sight to provide an electronic display of imagery captured by the forward-mounted camera and the one or more peripheral cameras, and each of the one or more smart devices adjustably mounted to the mounting rail of the firearm or a helmet mounting rail positioned on a helmet of the user to permit the user to view a target and an environment surrounding the user.
